(19) United States
(12) Patent Application Publication
(10) Pub. No.: US 2025/0158787 A1
(43) Pub. Date: May 15, 2025

(54) TECHNIQUES FOR TIME-DOMAIN CHANNEL QUALITY INFORMATION REPORTING RELATIVE TO A REFERENCE RESOURCE

(71) Applicant: QUALCOMM INCORPORATED, San Diego, CA (US)

(72) Inventors: Jing Dai, Beijing (CN); Chao Wei, Beijing (CN); Chenxi Hao, Beijing (CN); Liangming Wu, Beijing (CN); Min Huang, Beijing (CN); Wei Xi, Beijing (CN); Hao Xu, Beijing (CN)

(21) Appl. No.: 18/838,509

(22) PCT Filed: Apr. 22, 2022
(86) PCT No.: PCT/CN2022/088373

§ 371 Date: Aug. 14, 2024

(51) Int. Cl. H04L 5/00; H04B 7/06; H04W 24/10

(52) U.S. Cl. CPC H04L 5/0057; H04B 7/0626; H04W 24/10

(57) ABSTRACT

Methods, systems, and devices for wireless communications are described. A user equipment (UE) may receive control signaling indicating a channel state information (CSI) reporting configuration for time-domain CSI reporting associated with a set of time intervals and a CSI reference resource, where the CSI reference resource is included within one of the set of time intervals. In other words, the CSI reporting configuration may define an association, alignment, or arrangement between the CSI reference resource and the set of time intervals. The UE may perform measurement of, prediction based on, or both, one or more CSI-RSs in accordance with the CSI reporting configuration. The UE may then transmit a time-domain CSI report indicating time-domain CSI associated with the set of time intervals, where the alignment enables the network to determine which time intervals correspond to the respective time-domain CSI.

### CROSS REFERENCE

The present Application is a 371 national stage filing of International PCT Application No. PCT/CN2022/088373 by Dai et al. entitled “TECHNIQUES FOR TIME-DOMAIN CHANNEL QUALITY INFORMATION REPORTING RELATIVE TO A REFERENCE RESOURCE,” filed Apr. 22, 2022, which is assigned to the assignee hereof, and which is expressly incorporated by reference in its entirety herein.

### FIELD OF TECHNOLOGY

The following relates to wireless communications, including techniques for time-domain channel quality information (CQI) reporting relative to a reference resource.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, UEs are configured to measure reference signals (e.g., channel state information (CSI) reference signals (CSI-RSs)) received from the network, and transmit CSI reports to inform the network as to the relative quality and performance of a channel between the UE and the network. Some CSI reports may be based on CSI-RSs received at a specific instance in time, and may therefore provide the network with a “snapshot” of the channel performance at the specific instance in time. However, channel quality between the UE and the network may change frequently, such as when the UE moves around within the network.

### SUMMARY

The described techniques relate to improved methods, systems, devices, and apparatuses that support techniques for time-domain channel quality information (CQI) reporting relative to a reference resource. Generally, aspects of the present disclosure support techniques which enable user equipments (UEs) to report time-domain channel state information (CSI) for multiple time instances. In particular, aspects of the present disclosure support CSI reporting configurations which define an alignment between multiple time intervals and a CSI reference resource to facilitate efficient time-domain CSI reporting. In other words, the CSI reference resource is included within one of the time intervals such that the reported CSI measurements may be indicated for each respective time interval relative to the CSI reference resource. By defining an alignment between time intervals and the CSI reference resource, a UE can report multiple CSI measurements for the multiple time intervals (e.g., “time-domain CSI”) to provide the network with information as to how the channel quality between the UE and the network changes over the respective time intervals. In some implementations, aspects of the present disclosure may enable UEs to report time-domain CSI based on measured CSI, predicted/extrapolated CSI, or both.

A method for wireless communication at a UE is described. The method may include receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals and transmitting, to the network entity and based on the CSI reporting configuration, a time-domain CSI report indicating time-domain CSI, predicted time-domain CSI, or both, associated with the set of multiple time intervals.

An apparatus for wireless communication at a UE is described. The apparatus may include a processor, memory coupled with the processor, and instructions stored in the memory. The instructions may be executable by the processor to cause the apparatus to receive, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals and transmit, to the network entity and based on the CSI reporting configuration, a time-domain CSI report indicating time-domain CSI, predicted time-domain CSI, or both, associated with the set of multiple time intervals.

Another apparatus for wireless communication at a UE is described. The apparatus may include means for receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals and means for transmitting, to the network entity and based on the CSI reporting configuration, a time-domain CSI report indicating time-domain CSI, predicted time-domain CSI, or both, associated with the set of multiple time intervals.

A non-transitory computer-readable medium storing code for wireless communication at a UE is described. The code may include instructions executable by a processor to receive, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals and transmit, to the network entity and based on the CSI reporting configuration, a time-domain CSI report indicating time-domain CSI, predicted time-domain CSI, or both, associated with the set of multiple time intervals.

Some examples of the method, apparatuses, and non-transitory computer-readable medium described herein may further include operations, features, means, or instructions for transmitting, via the time-domain CSI report, one or more precoding matrix indicators (PMIs) associated with the set of multiple time intervals, where the one or more PMIs may be based on the time-domain CSI.

Some examples of the method, apparatuses, and non-transitory computer-readable medium described herein may further include operations, features, means, or instructions for performing measurement of, prediction based on, or both, one or more CSI reference signals (CSI-RSs) in accordance with the CSI reporting configuration and transmitting, via the time-domain CSI report, an indication of measured time-domain CSI, predicted time-domain CSI, or both, associated with the set of multiple time intervals, where the measured time-domain CSI, the predicted time-domain CSI, or both, may be based on the performing.

In some examples of the method, apparatuses, and non-transitory computer-readable medium described herein, the CSI reporting configuration may be associated with an alignment between the CSI reference resource and a temporally first time interval of the set of multiple time intervals and the method, apparatuses, and non-transitory computer-readable medium may include further operations, features, means, or instructions for determining the predicted time-domain CSI based on the measurement of the one or more CSI-RSs received within the temporally first time interval, within the CSI reference resource, or both, where the time-domain CSI report includes the predicted time-domain CSI.

In some examples of the method, apparatuses, and non-transitory computer-readable medium described herein, the CSI reporting configuration may be associated with an alignment between the CSI reference resource and a temporally last time interval of the set of multiple time intervals and the method, apparatuses, and non-transitory computer-readable medium may include further operations, features, means, or instructions for determining measured time-domain CSI based on the measurement of the one or more CSI-RSs received prior to the CSI reference resource and during the set of multiple time intervals, where the time-domain CSI includes the measured time-domain CSI.

In some examples of the method, apparatuses, and non-transitory computer-readable medium described herein, the CSI reporting configuration may be associated with an alignment between the CSI reference resource and an indicated time interval of the set of multiple time intervals and the method, apparatuses, and non-transitory computer-readable medium may include further operations, features, means, or instructions for determining measured time-domain CSI associated with a first subset of the set of multiple time intervals prior to the indicated time interval based on the measurement of the one or more CSI-RSs received prior to the CSI reference resource and during the first subset of the set of multiple time intervals and determining predicted time-domain CSI associated with a second subset of the set of multiple time intervals subsequent to the indicated time interval based on the measurement of the one or more CSI-RSs received prior to the CSI reference resource and during the first subset of the set of multiple time intervals, where the time-domain CSI includes the measured time-domain CSI associated with the first subset of time intervals and the predicted time-domain CSI associated with the second subset of time intervals.

Some examples of the method, apparatuses, and non-transitory computer-readable medium described herein may further include operations, features, means, or instructions for determining an alignment between a time interval of the set of multiple time intervals and the CSI reference resource based on the CSI reporting configuration and transmitting, via the time-domain CSI report, an indication of the determined alignment.

In some examples of the method, apparatuses, and non-transitory computer-readable medium described herein, the CSI reporting configuration may be associated with a set of multiple CSI reference resources within the set of multiple time intervals and the time-domain CSI may be associated with one or more time intervals of the set of multiple time intervals that include at least one CSI reference resource from the set of multiple CSI reference resources.

In some examples of the method, apparatuses, and non-transitory computer-readable medium described herein, a time interval of the set of multiple time intervals includes a set of one or more CSI reference resources and the time-domain CSI indicated via the time-domain CSI report may be based on at least one of the one or more CSI reference resources.

In some examples of the method, apparatuses, and non-transitory computer-readable medium described herein, the time-domain CSI report may be associated with at least a first time interval of the set of multiple time intervals and the time-domain CSI may be associated with an identified subband of the first time interval, a set of multiple subbands of the first time interval, or both.

In some examples of the method, apparatuses, and non-transitory computer-readable medium described herein, the CSI reporting configuration may be associated with an alignment between the CSI reference resource and a temporally first slot of a time interval of the set of multiple time intervals, or an alignment between the CSI reference resource and a temporally last slot of the time interval of the set of multiple time intervals.

In some examples of the method, apparatuses, and non-transitory computer-readable medium described herein, the CSI reference resource may be associated with a single time interval of the set of multiple time intervals and the time-domain CSI may be associated with the single time interval.

A method for wireless communication at a network entity is described. The method may include transmitting, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals, transmitting one or more CSI-RSs in accordance with the CSI reporting configuration, and receiving, from the UE and based on the transmitting the one or more CSI-RSs, a time-domain CSI report indicating time-domain CSI associated with the set of multiple time intervals.

An apparatus for wireless communication at a network entity is described. The apparatus may include a processor, memory coupled with the processor, and instructions stored in the memory. The instructions may be executable by the processor to cause the apparatus to transmit, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals, transmit one or more CSI-RSs in accordance with the CSI reporting configuration, and receive, from the UE and based on the transmitting the one or more CSI-RSs, a time-domain CSI report indicating time-domain CSI associated with the set of multiple time intervals.

Another apparatus for wireless communication at a network entity is described. The apparatus may include means for transmitting, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals, means for transmitting one or more CSI-RSs in accordance with the CSI reporting configuration, and means for receiving, from the UE and based on the transmitting the one or more CSI-RSs, a time-domain CSI report indicating time-domain CSI associated with the set of multiple time intervals.

A non-transitory computer-readable medium storing code for wireless communication at a network entity is described. The code may include instructions executable by a processor to transmit, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals, transmit one or more CSI-RSs in accordance with the CSI reporting configuration, and receive, from the UE and based on the transmitting the one or more CSI-RSs, a time-domain CSI report indicating time-domain CSI associated with the set of multiple time intervals.

Some examples of the method, apparatuses, and non-transitory computer-readable medium described herein may further include operations, features, means, or instructions for receiving, via the time-domain CSI report, one or more PMIs associated with the set of multiple time intervals, where the one or more PMIs based on the measured time-domain CSI, the predicted time-domain CSI, or both.

In some examples of the method, apparatuses, and non-transitory computer-readable medium described herein, the CSI reporting configuration may be associated with an alignment between the CSI reference resource and a temporally first time interval of the set of multiple time intervals, the predicted time-domain CSI may be based on the one or more CSI-RSs transmitted within the temporally first time interval, within the CSI reference resource, or both, and the time-domain CSI report includes the predicted time-domain CSI.

In some examples of the method, apparatuses, and non-transitory computer-readable medium described herein, the CSI reporting configuration may be associated with an alignment between the CSI reference resource and a temporally last time interval of the set of multiple time intervals, the measured time-domain CSI may be based on the one or more CSI-RSs transmitted prior to the CSI reference resource and during the set of multiple time intervals, and the time-domain CSI report includes the measured time-domain CSI.

In some examples of the method, apparatuses, and non-transitory computer-readable medium described herein, the CSI reporting configuration may be associated with an alignment between the CSI reference resource and an indicated time interval of the set of multiple time intervals, the measured time-domain CSI may be associated with a first subset of the set of multiple time intervals prior to the indicated time interval based on the one or more CSI-RSs transmitted prior to the CSI reference resource and during the first subset of the set of multiple time intervals, the predicted time-domain CSI may be associated with a second subset of the set of multiple time intervals subsequent to the indicated time interval based on the one or more CSI-RSs transmitted prior to the CSI reference resource and during the first subset of the set of multiple time intervals, and the time-domain CSI report includes the measured time-domain CSI associated with the first subset of time intervals and the predicted time-domain CSI associated with the second subset of time intervals.

Some examples of the method, apparatuses, and non-transitory computer-readable medium described herein may further include operations, features, means, or instructions for receiving, via the time-domain CSI report, an indication of an alignment between a time interval of the set of multiple time intervals and the CSI reference resource based on the CSI reporting configuration.

In some examples of the method, apparatuses, and non-transitory computer-readable medium described herein, the CSI reporting configuration may be associated with a set of multiple CSI reference resources within the set of multiple time intervals and the measured time-domain CSI may be associated with one or more time intervals of the set of multiple time intervals that include at least one CSI reference resource from the set of multiple CSI reference resources.

In some examples of the method, apparatuses, and non-transitory computer-readable medium described herein, a time interval of the set of multiple time intervals includes a set of one or more CSI reference resources and the measured time-domain CSI indicated via the time-domain CSI report may be based on at least one of the one or more CSI reference resources.

In some examples of the method, apparatuses, and non-transitory computer-readable medium described herein, the time-domain CSI report may be associated with at least a first time interval of the set of multiple time intervals and the measured time-domain CSI, the predicted time-domain CSI, or both, may be associated with an identified subband of the first time interval, a set of multiple subbands of the first time interval, or both.

In some examples of the method, apparatuses, and non-transitory computer-readable medium described herein, the CSI reporting configuration may be associated with an alignment between the CSI reference resource and a temporally first slot of a time interval of the set of multiple time intervals, or an alignment between the CSI reference resource and a temporally last slot of the time interval of the set of multiple time intervals.

### BRIEF DESCRIPTION OF THE DRAWINGS

FIG. 1 illustrates an example of a wireless communications system that supports techniques for time-domain channel quality information (CQI) reporting relative to a reference resource in accordance with one or more aspects of the present disclosure.

FIG. 2 illustrates an example of a channel state information (CSI) reporting configuration that supports techniques for time-domain CQI reporting relative to a reference resource in accordance with one or more aspects of the present disclosure.

FIG. 3 illustrates an example of a wireless communications system that supports techniques for time-domain CQI reporting relative to a reference resource in accordance with one or more aspects of the present disclosure.

FIG. 4 illustrates an example of a CSI reporting configuration that supports techniques for time-domain CQI reporting relative to a reference resource in accordance with one or more aspects of the present disclosure.

FIG. 5 illustrates an example of a process flow that supports techniques for time-domain CQI reporting relative to a reference resource in accordance with one or more aspects of the present disclosure.

FIGS. 6 and 7 show block diagrams of devices that support techniques for time-domain CQI reporting relative to a reference resource in accordance with one or more aspects of the present disclosure.

FIG. 8 shows a block diagram of a communications manager that supports techniques for time-domain CQI reporting relative to a reference resource in accordance with one or more aspects of the present disclosure.

FIG. 9 shows a diagram of a system including a device that supports techniques for time-domain CQI reporting relative to a reference resource in accordance with one or more aspects of the present disclosure.

FIGS. 10 and 11 show block diagrams of devices that support techniques for time-domain CQI reporting relative to a reference resource in accordance with one or more aspects of the present disclosure.

FIG. 12 shows a block diagram of a communications manager that supports techniques for time-domain CQI reporting relative to a reference resource in accordance with one or more aspects of the present disclosure.

FIG. 13 shows a diagram of a system including a device that supports techniques for time-domain CQI reporting relative to a reference resource in accordance with one or more aspects of the present disclosure.

FIGS. 14 through 18 show flowcharts illustrating methods that support techniques for time-domain CQI reporting relative to a reference resource in accordance with one or more aspects of the present disclosure.

### DETAILED DESCRIPTION

In some wireless communications systems, user equipments (UEs) are configured to measure reference signals (e.g., channel state information (CSI) reference signals (CSI-RSs)) received from the network, and transmit CSI reports to inform the network as to the relative quality and performance of a channel between the UE and the network. Some CSI reports may be based on CSI-RSs received at a specific instance in time, and may therefore provide the network with a “snapshot” of the channel performance at the specific instance in time. However, channel quality between the UE and the network may change frequently, such as when the UE moves around within the network. As such, UEs may be expected to frequently transmit CSI reports, particularly in high-mobility scenarios, to inform the network as to changing channel qualities experienced at the UE. This may lead to increased control signaling and network traffic. Moreover, traditional CSI reports are reactive in that they only provide the network information associated with measured channel conditions in the past, and do not provide any forward-looking measurements to enable the network to dynamically adjust/predict parameters for future communications. As such, conventional CSI reporting techniques are deficient.

Accordingly, aspects of the present disclosure are directed to techniques which enable UEs to report time-domain CSI for multiple time instances. In other words, aspects of the present disclosure enable UEs to transmit “time-domain CSI reports” associated with CSI measured at multiple points in time to enable the UE to report how CSI changes over time. In particular, aspects of the present disclosure support CSI reporting configurations which define an alignment between multiple time intervals and a CSI reference resource. In other words, CSI reporting techniques described herein may define a relative alignment between the CSI reference resource and the set of time intervals such that the CSI reference resource is included within one of the time intervals. By defining an alignment between the set of time intervals and the CSI reference resource, a UE can report multiple CSI metrics for the multiple time intervals (e.g., “time-domain CSI”) to provide the network with information as to how the channel quality between the UE and the network changes over time.

Techniques described herein may enable UEs to report time-domain CSI reports, which may provide the network with a more complete and comprehensive picture as to how a relative quality of a channel between the UE and the network changes over time. In particular, CSI reporting configurations described herein may include or define an association between a set of time intervals and a CSI reference resource (e.g., an alignment between the CSI reference resource and a time interval included within the set of time intervals associated with a time-domain CSI report). As such, by indicating an association between the set of time intervals and the CSI reference resource, the network may be able to efficiently determine which reported CSI measurements and/or precoding matrix indicators (PMIs) indicated via the time-domain CSI report correspond to which time intervals, thereby enabling the network to determine how the relative channel quality has changed (or is expected to change) over time.

In some implementations, CSI reporting configurations described herein may enable UEs to report time-domain CSI based on measured CSI, predicted/extrapolated CSI, or both. In other words, the relative alignment between the CSI reference resource and the respective time interval may determine whether the UE is expected to report CSI measurements for time intervals in the past, or report predicted/extrapolated CSI measurements for time intervals in the future.

For example, a UE may receive a CSI reporting configuration for a set of time intervals (e.g., set of subtimes) that are to be reported for CSI, where the CSI reporting configuration indicates an alignment between the time intervals and a CSI reference resource. Stated differently, the CSI reference resource may be included within (e.g., aligned with) one of the time intervals that is to be reported for CSI. The alignment between the CSI reference resource and the respective time interval may be indicated by the network, selected by the UE, or both. The alignment associated with the CSI reporting configuration may align the CSI reference resource with a temporally first time interval, a temporally last time interval, or an Nth time interval. Moreover, the alignment between the CSI reference resource and the respective time interval may enable the network to determine which CSI measurements and/or PMIs indicated via the time-domain CSI report correspond to which time intervals, thereby enabling the network to determine/predict how the channel quality between the UE and the network has (or is expected) to change over time.

The relative alignment of the time intervals to the CSI reference resource may determine whether the UE will report measured CSI measurements, predicted/extrapolated CSI measurements, or both. For instance, if the CSI reference resource is aligned with a temporally first time interval, a time-domain CSI report may include predicted CSI metrics for the time intervals which are predicted/extrapolated/estimated based on CSI measurements performed prior to and/or during the CSI reference resource. In other words, if the CSI reference resource is aligned with the temporally first time interval, the network may be configured to determine that reported CSI measurements and/or reported PMIs are associated with time intervals in the future, and are therefore include predicted/extrapolated/estimated CSI measurements and predicted/extrapolated/estimated PMIs.

Conversely, if the CSI reference resource is aligned with a temporally last time interval, a time-domain CSI report may include measured CSI metrics for the time intervals (e.g., no prediction/extrapolation/estimation). In other words, if the CSI reference resource is aligned with the temporally last time interval, the network may be configured to determine that reported CSI measurements and/or reported PMIs are associated with time intervals that are prior to the CSI reference resource, and are therefore include measured CSI measurements and calculated PMIs. Further, if the CSI reference resource is aligned with an Nth time interval, the time-domain CSI report may include both measured CSI measurements for time intervals prior to the CSI reference resource and predicted CSI measurements for time intervals after the CSI reference resource.

Techniques described herein may enable UEs to be configured with different time-domain CSI reporting configurations which cause the UEs to report time-domain CSI (e.g., report changing CSI measurements and/or changing PMIs over time) for time intervals in the past, time intervals in the future, or both. In particular, techniques described herein may enable the network to adjust a relative alignment of CSI reference resources with sets of time intervals reported for CSI to adjust whether the UE will report measured CSI/calculated PMIs for time intervals in the past, report predicted/expected CSI measurements and PMIs for time intervals in the future, or both. As such, techniques described herein may provide the network with a more complete and comprehensive picture regarding how channel conditions between the UE and the network have evolved over time, and may enable the network to dynamically adjust and/or predict communication parameters for future communications with the UE.

Aspects of the disclosure are initially described in the context of wireless communications systems. Additional aspects of the disclosure are described in the context of example CLI reporting configurations and an example process flow. Aspects of the disclosure are further illustrated by and described with reference to apparatus diagrams, system diagrams, and flowcharts that relate to techniques for time-domain CQI reporting relative to a reference resource.

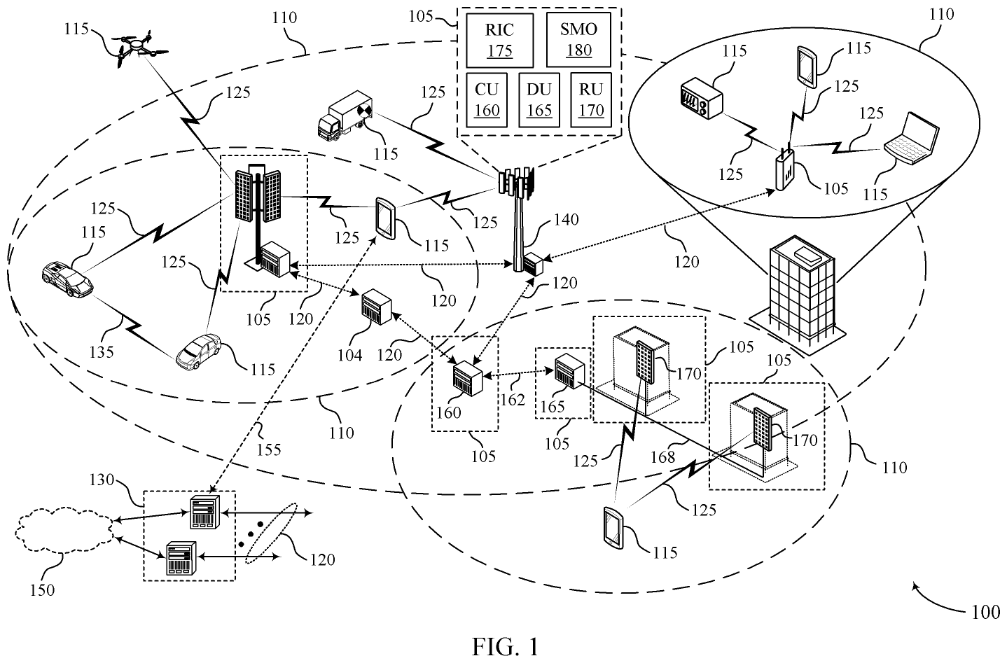

FIG. 1 illustrates an example of a wireless communications system 100 that supports techniques for time-domain CQI reporting relative to a reference resource in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for time-domain CQI reporting relative to a reference resource as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS, which may be precoded or unprecoded. The UE 115 may provide feedback for beam selection, which may be a PMI (PMI) or codebook-based feedback (e.g., a multi-panel type codebook, a linear combination type codebook, a port selection type codebook). Although these techniques are described with reference to signals transmitted along one or more directions by a network entity 105 (e.g., abase station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, the UEs 115 and the network entities 105 (e.g., base stations) of the wireless communications system 100 may support techniques which enable UEs 115 to report time-domain CSI for multiple time instances. In other words, the wireless communications system 100 may enable a UE 115 to transmit “time-domain CSI reports” associated with CSI measured at multiple points in time to enable the UE 115 to report how CSI changes over time. In particular, aspects of the present disclosure support CSI reporting configurations which define an association between multiple time intervals and a CSI reference resource. In other words, CSI reporting techniques described herein may define a relative alignment (e.g., association) between the CSI reference resource and the set of time intervals such that the CSI reference resource is included within one of the time intervals. By defining an association (e.g., alignment) between the set of time intervals and the CSI reference resource, the UE 115 can report multiple CSI metrics for the multiple time intervals (e.g., “time-domain CSI”) to provide the network with information as to how the channel quality between the UE 115 and the network changes over time.

In some implementations, CSI reporting configurations described herein may enable UEs 115 to report time-domain CSI based on measured CSI, predicted/extrapolated CSI, or both. For example, a UE 115 of the wireless communications system 100 may receive a CSI reporting configuration for a set of time intervals (e.g., set of subtimes) that are to be reported for CSI, where the CSI reporting configuration indicates an alignment between the time intervals and a CSI reference resource. Stated differently, the CSI reference resource may be included within (e.g., aligned with) one of the time intervals that is to be reported for CSI. The alignment between the CSI reference resource and the respective time interval may be indicated by the network, selected by the UE 115, or both. The alignment associated with the CSI reporting configuration may align the CSI reference resource with a temporally first time interval, a temporally last time interval, or an Nth time interval. Moreover, the alignment between the CSI reference resource and the respective time interval may enable the network to determine which CSI measurements and/or PMIs indicated via the time-domain CSI report correspond to which time intervals, thereby enabling the network to determine/predict how the channel quality between the UE 115 and the network has (or is expected) to change over time.

The relative alignment of the time intervals to the CSI reference resource may determine whether the UE 115 will report measured CSI measurements, predicted/extrapolated CSI measurements, or both. For instance, if the CSI reference resource is aligned with a temporally first time interval, a time-domain CSI report may include predicted CSI metrics for the time intervals which are predicted/extrapolated based on CSI measurements performed prior to and/or during the CSI reference resource. In other words, if the CSI reference resource is aligned with the temporally first time interval, the network may be configured to determine that reported CSI measurements and/or reported PMIs are associated with time intervals in the future, and are therefore include predicted/extrapolated CSI measurements and predicted/extrapolated PMIs.

Conversely, if the CSI reference resource is aligned with a temporally last time interval, a time-domain CSI report may include measured CSI metrics for the time intervals (e.g., no prediction/extrapolation). In other words, if the CSI reference resource is aligned with the temporally last time interval, the network may be configured to determine that reported CSI measurements and/or reported PMIs are associated with time intervals that are prior to the CSI reference resource, and are therefore include measured CSI measurements and calculated PMIs. Further, if the CSI reference resource is aligned with an Nth time interval, the time-domain CSI report may include both measured CSI measurements for time intervals prior to the CSI reference resource and predicted CSI measurements for time intervals after the CSI reference resource.

Techniques described herein may enable UEs 115 to report time-domain CSI reports, which may provide the network with a more complete and comprehensive picture as to how a relative quality of a channel between the UE 115 and the network changes over time. In particular, CSI reporting configurations described herein may include or define an alignment between a CSI reference resource and a time interval included within a set of time intervals associated with a time-domain CSI report. As such, by defining an alignment between the CSI reference resource and the respective time interval, the network may be able to efficiently determine which reported CSI measurements and/or PMIs indicated via the time-domain CSI report correspond to which time intervals, thereby enabling the network to determine how the relative channel quality has changed (or is expected to change) over time.

Moreover, techniques described herein may enable UEs 115 to be configured with different time-domain CSI reporting configurations which cause the UEs 115 to report time-domain CSI (e.g., report changing CSI measurements and/or changing PMIs over time) for time intervals in the past, time intervals in the future, or both. As such, techniques described herein may enable the network to adjust a relative alignment of a CSI reference resource with sets of time intervals reported for CSI to adjust whether the UE 115 will report measured CSI/calculated PMIs for time intervals in the past, report predicted/expected CSI measurements and PMIs for time intervals in the future, or both.

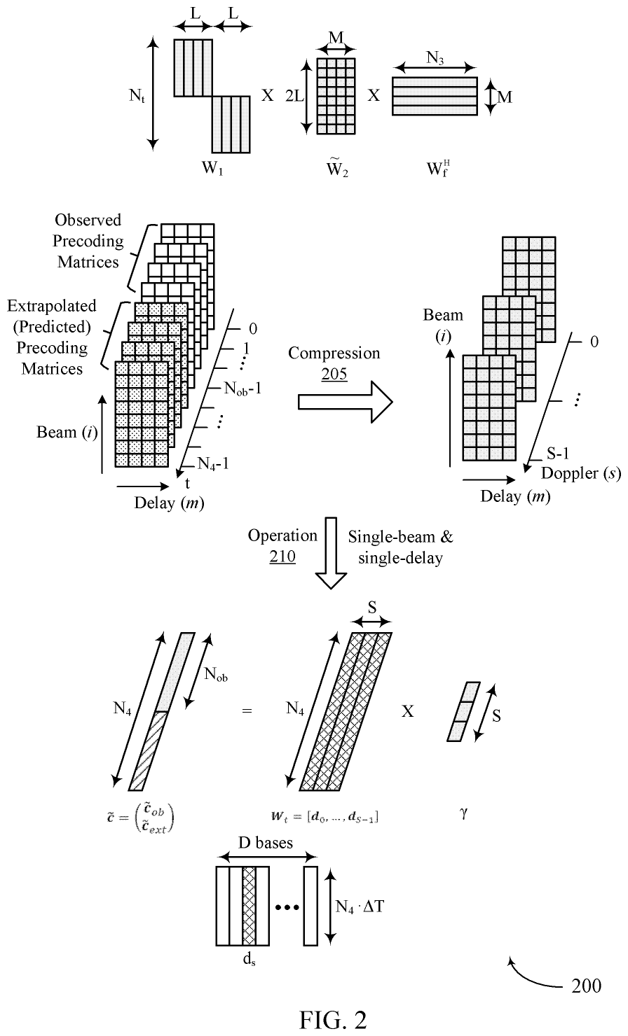

FIG. 2 illustrates an example of a CSI reporting configuration 200 that supports techniques for time-domain CQI reporting relative to a reference resource in accordance with one or more aspects of the present disclosure. In particular, the CSI reporting configuration 200 illustrates an example of eType-II CSI reporting.

In the context of CSI reporting, and as illustrated in FIG. 2, a precoding matrix (W) for a layer may be defined according to Equation 1 below:

$$W = {W}_{1} \times {\tilde{W}}_{2} \times {W}_{f}^{H} \qquad ( 1 )$$

where W₁ indicates selected spatial-domain bases, W_{f}^{H} indicates selected frequency-domain bases, and \tilde{W}₂ indicates a coefficient matrix (e.g., PMI).

As noted previously herein, channel conditions between a UE 115 and the network may change frequently, particularly in medium and high-velocity scenarios (e.g., cases where the UE 115 is aboard a high-velocity train). As such, to accommodate for channel conditions changing over time, UEs 115 may utilize different precoding matrices over time, where precoding matrices are associated with or indicated via PMIs. For medium and high velocity channels, wireless devices may use a time-domain codebook to represent the fast-varying (over time instance n) precoding matrix, as illustrated in Equation 2 below:

$$W ( n ) = {W}_{1} \times {\tilde{W}}_{2} ( n ) \times {W}_{f}^{H} \qquad ( 2 )$$

Wireless devices (e.g., UEs 115) may perform compression procedures to compress time-domain CSI from the time domain to the Doppler domain (e.g., time-domain compression). Compression of the coefficient matrix \tilde{W}₂(n) into the Doppler domain is illustrated in Equation 3 below:

$${\tilde{W}}_{2} ( n ) = {[ {\tilde{c}}_{i , m} ( n ) ]}_{\begin{matrix}i = 0 , … , 2 L - 1 \\ m = 0 , … , M - 1\end{matrix}} \qquad ( 3 )$$

$$n = 0 , … , {N}_{4} - 1$$

Time-domain compression is further illustrated via the compression 205 illustrated in FIG. 2. As shown in FIG. 2, a UE 115 may convert both observed and predicted/extrapolated precoding matrices from the time domain to the Doppler domain via compression 205. Each precoding matrix may be associated with a beam domain (i) and a delay domain (m). The observed and extrapolated precoding matrices may be calculated for different time instances or time intervals (e.g., time intervals 0, 1, N_{ob}−1, . . . , N₄−1). The observed precoding matrices may be determined/calculated on CSI measurements actually performed by the UE 115 (e.g., for time intervals in the past). Comparatively, the predicted/extrapolated precoding matrices may be predicted/extrapolated into the future based on performed CSI measurements (e.g., for time intervals in the future). In other words, the predicted/extrapolated precoding matrices may include precoding matrices the UE 115 expects to use in the future based on past CSI measurements.

Compression of the coefficient matrix \tilde{W}₂(n) according to Equation 3 above may result in Equation 4 and Equation 5 below:

$${\tilde{c}}_{i , m} ( n ) = {\sum }_{s = 0}^{S - 1} {d}_{s , i , m} ( n ) \cdot {γ}_{s , i , m} , \qquad ( 4 )$$

$$n = 0 , … , {N}_{4} - 1$$

$${\tilde{c}}_{i , m} = {[ {W}_{t} ]}_{i , m} \times {γ}_{i , m} = [ {d}_{0 , i , m} , … , {d}_{S - 1 , i , m} ] \times {γ}_{i , m} \qquad ( 5 )$$

For single-beam and single-delay scenarios, beam index i and delay index m may be omitted or dropped, as illustrated in operation 210 illustrated in FIG. 2, which may result in Equation 6 and Equation 7 below:

$$\tilde{c} = ( \begin{matrix}{\tilde{c}}_{ob} \\ {\tilde{c}}_{ext}\end{matrix} ) = {W}_{t} \times γ = [ {d}_{0} , … , {d}_{S - 1} ] \times γ \qquad ( 6 )$$

$${d}_{s} = {[ 1 , {e}^{j 2 π \frac{s}{D}} , … , {e}^{j 2 π \frac{s ( {N}_{4} - 1 )}{D}} ]}^{T} , \qquad ( 7 )$$

$$s = 0 , 1 , … , D$$

where dₛ, s=0,1, . . . , S−1 is the selected time-domain bases to form a time-domain basis matrix Wₜ, \tilde{c}_{ob} is the spatial and frequency-domain bases coefficients for observed CSI-RSs, \tilde{c}ₑₓₜ is the extrapolated spatial and frequency-domain bases coefficients, and γ defines the coefficients jointly with spatial-domain, frequency-domain, and time-domain.

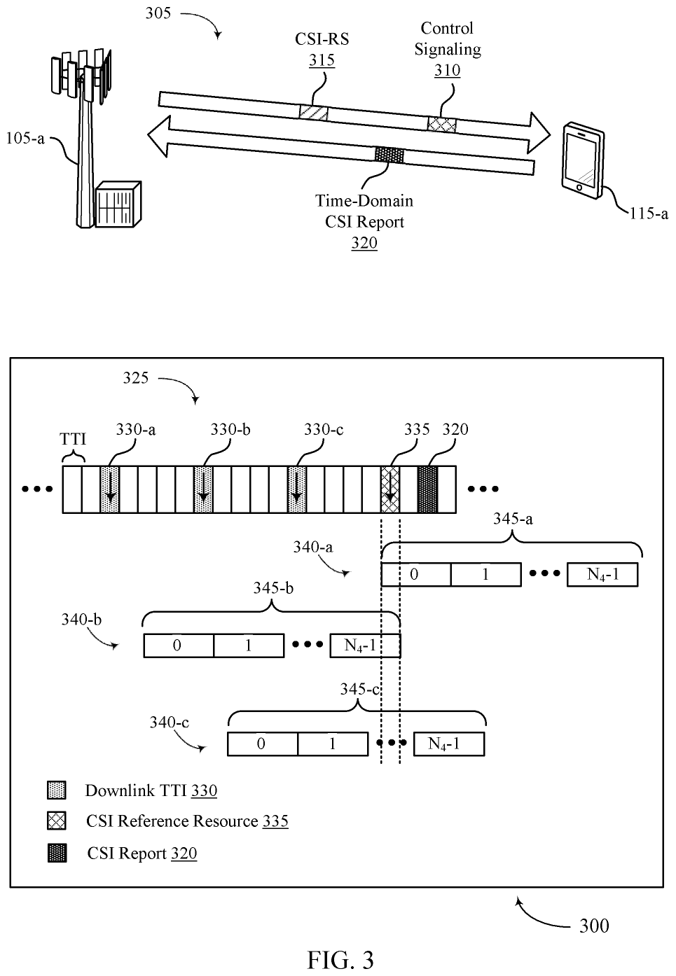

FIG. 3 illustrates an example of a wireless communications system 300 that supports techniques for time-domain CQI reporting relative to a reference resource in accordance with one or more aspects of the present disclosure. In some examples, aspects of the wireless communications system 300 may implement, or be implemented by, aspects of the wireless communications system 100, the CSI reporting configuration 200, or both. In particular, the wireless communications system 300 may support signaling and configurations for time-domain CSI reporting, as described herein.

The wireless communications system 300 may include a network entity 105-a, and a UE 115-a, which may be examples of network entities 105 and UEs 115 as described with reference to FIG. 1. The UE 115-a may communicate with the network entity 105-a using a communication link 305, which may be an example of an NR or LTE link between the UEs 115-a and the network entity 105-a. In some cases, the communication link 305 between the UE 115-a and the network entity 105-a may include an example of an access link (e.g., Uu link) which may include bi-directional links that enable both uplink and downlink communication. For example, the UE 115-a may transmit uplink signals, such as uplink control signals or uplink data signals, to one or more components of the network entity 105-a using the communication link 305, and one or more components of the network entity 105-a may transmit downlink signals, such as downlink control signals or downlink data signals, to the UE 115-a using the communication link 305.

As described previously herein, the wireless communications system 300 may support signaling and configurations which enable the UE 115-a to report time-domain CSI for multiple time instances. In other words, the wireless communications system 300 may support techniques which enable the UE 115-a to transmit time-domain CSI reports 320 associated with CSI measured at multiple points in time to enable the UE 115-a to report how CSI changes over time. In some aspects, the wireless communications system 300 may support CSI reporting for high/medium UE 115-a velocities by exploiting time-domain correlation/Doppler-domain information to assist downlink precoding, and to enable UE-reporting of time-domain channel properties measured via CSI-RS for tracking.

In particular, aspects of the present disclosure support CSI reporting configurations 340 which define an association between multiple time intervals 345 and a CSI reference resource 335. In other words, CSI reporting techniques described herein may define a relative alignment (e.g., association) between the CSI reference resource 335 and the set of time intervals 345 such that the CSI reference resource 335 is included within one of the time intervals 345.

In some wireless communications systems, a CSI reference resource 335 may include a slot or other TTI that is defined for validation testing (e.g., target block error rate (BLER) of ten percent) with the reported CQI (and PMI, if also reported). A CSI reference resource 335 may include or be associated with frequency, time, and spatial resources. A frequency resource of the CSI reference resource 335 may be the same as resources used to measure CSI-RSs 315 in the frequency domain. In other words, the CSI reference resource 335 may be associated with a same frequency resource(s) as downlink TTIs 330 used for transmission/reception of CSI-RSs 315. The time resource associated with the CSI reference resource 335 may include a valid downlink slot (e.g., slot n−n_{CSI_ref}) prior to an uplink slot (e.g., slot n) where a CSI report 320 is transmitted/reported. The CSI reference resource 335 may include a defined PDSCH pattern, including used symbols within the respective slot, a DMRS pattern, an SCS, a layer mapping pattern associated with the reported PMI, and the like.

In the context of periodic and/or semi-persistent CSI reporting, the slot/TTI for the CSI reference resource, n_{CSI_ref}, is the smallest value that is greater than or equal to 4·2^{μDL} (for single-reference signal CSI reports 320) or greater than or equal to 5·2^{μDL} (for multi-reference signal CSI reports 320), such that slot n−n_{CSI_ref} for the CSI reference resource 335 corresponds to a valid downlink slot. Comparatively, in the context of aperiodic CSI reporting, n_{CSI_ref} for the CSI reference resource 335 is the smallest value that is greater than or equal to [Z′/14], such that slot n−n_{CSI_ref} corresponds to a valid downlink slot, where Z′ is the required processing timeline for processing CSI-RS 315 and reporting a CSI report 320 via PUSCH.

As noted previously herein, the UE 115-a of the wireless communications system 300 may be configured to transmit time-domain CSI reports 320 associated with multiple time instances/time intervals 345. In other words, time-domain CSI reports 320 transmitted by the UE 115-a may be associated with measured/predicted CSI measurements across a set of time intervals 345.

In order to enable the network entity 105-a to determine which reported CSI measurements/predictions and/or reported PMIs within time-domain CSI reports 320 correspond to which time intervals, techniques described herein may define an alignment between multiple time intervals 345 and a CSI reference resource 335. In other words, CSI reporting techniques described herein may define an association between a set of time intervals and a CSI reference resource (e.g., a relative alignment, arrangement, or other association between the CSI reference resource 335 and the set of time intervals 345 such that the CSI reference resource 335 is included within one of the time intervals 345). As such, techniques described herein may enable the UE 115-a to associate multi-instance PMIs to the CSI reference resource 335 and report corresponding CSI/CQI metrics such that the network entity 105-a is able to determine which CSI measurements/PMIs correspond to which time intervals 345. In other words, by defining an association between the set of time intervals and a CSI reference resource (e.g., an alignment, arrangement, or other association between a set of time intervals 345 associated with a CSI report 320 and the CSI reference resource 335), the UE 115-a can report multiple CSI metrics for the multiple time intervals 345 (e.g., “time-domain CSI”) to provide the network entity 105-a with information as to how the channel quality between the UE 115-a and the network entity 105-a changes over time.

For example, as shown in FIG. 2, the UE 115-a may receive control signaling 310 from the network entity 105-a, where the control signaling 310 indicates a CSI reporting configuration 340 for time-domain CSI reporting associated with a set of time intervals 345 and a CSI reference resource 335. The control signaling 310 may include RRC signaling, MAC-CE signaling, DCI signaling, or any combination thereof.

In some aspects, the indicated CSI reporting configuration 340 may be associated with (or define) an alignment between a respective set of time intervals 345 and the CSI reference resource 335. In some aspects, the alignment associated with the CSI reporting configuration 340 may be determined/selected by the network entity 105-a and communicated to the UE 115-a via the control signaling 310. Additionally, or alternatively, the UE 115-a may determine/select the alignment between the set of time intervals 345 and the CSI reference resource 335 (e.g., based on the CSI reporting configuration 340). In cases where the UE 115-a selects the alignment associated with the CSI reporting configuration 340, the UE 115-a may indicate the determined/selected alignment to the network entity 105-a via a CSI report 320, as will be described in further detail herein.

The alignment associated with the CSI reporting configuration 340 may align the respective set of time intervals 345 with the CSI reference resource 335 such that the CSI reference resource 335 is included within a time interval of the set of time intervals 345. In other words, for time-domain codebook (basis) with time intervals/subtimes (ATs), one of the subtimes/time intervals of the reported PMI may contain/include the CSI reference resource 335. Stated differently, the alignment of a CSI reporting configuration 340 may align a set of time intervals 345 (e.g., time intervals n=0, 1, . . . N₄−1) such that the CSI reference resource 335 is included within one of the time intervals.

There are several alternatives or implementations for CSI reporting configurations 340 when associating or aligning a respective set of time intervals 345 with the CSI reference resource 335. Each CSI reporting configuration 340 may include a set of time intervals 345 which will be measured and/or predicted for CSI reporting, where the set of time intervals 345 is aligned with the CSI reference resource 335 in some manner.

In accordance with a first implementation, the reference resource slot may be associated with (e.g., aligned with or included within) the codebook's starting subtime/time interval. For example, referring to a first CSI reporting configuration 340-a, the CSI reference resource 335 may be included within or aligned with a temporally first time interval (e.g., time interval 0) of the set of time intervals 345-a. In other words, the alignment associated with the first CSI reporting configuration 340-a may align the CSI reference resource 335 and the temporally first time interval 0 such that the CSI reference resource 335 is positioned within the time interval 0 (e.g., temporally first time interval) of the set of time intervals 345-a in the time domain.

In accordance with a second implementation, the reference resource slot may be associated with (e.g., aligned with or included within) the codebook's ending subtime/time interval. For example, referring to a second CSI reporting configuration 340-b, the CSI reference resource 335 may be included within or aligned with a temporally last time interval (e.g., time interval N₄−1) of the set of time intervals 345-b. In other words, the alignment associated with the second CSI reporting configuration 340-b may align the CSI reference resource 335 and the temporally last time interval N₄−1 such that the CSI reference resource 335 is positioned within the time interval N₄−1 (e.g., temporally last time interval) of the set of time intervals 345-b in the time domain.

In accordance with a third implementation, the reference resource slot may be associated with (e.g., aligned with or included within) the codebook's Nth subtime/time interval. For example, referring to a third CSI reporting configuration 340-c, the CSI reference resource 335 may be included within or aligned with an Nth time interval (e.g., second, third, fourth, etc.) of the set of time intervals 345-c. In other words, the alignment associated with the third CSI reporting configuration 340-c may align the CSI reference resource 335 and the Nth time interval such that the CSI reference resource 335 is positioned within the Nth time interval of the set of time intervals 345-c in the time domain.

As noted previously herein, the alignment associated with the respective CSI reporting configuration 340 may be determined/selected by the network entity 105-a, by the UE 115-a, or both. For example, in some implementations, the alignment of the reference resource slot (e.g., CSI reference resource 335) and a subtime/time interval of the codebook may be decided by UE 115-a and reported along with the CSI measured/predicted by the UE 115-a (e.g., via a CSI report 320).

In some aspects, each time interval 345 (e.g., subtime) may span one or more slots or other TTIs. For example, in some cases, each time interval 345 may include or span five slots. Moreover, the alignment between the CSI reference resource 335 and a respective time interval 345 may be defined relative to a first, last, or Nth slot/TTI within the respective time intervals 345. For example, the alignment of the first CSI reporting configuration 340-a may align the CSI reference resource 335 with a first slot included within the temporally first time interval 345 (e.g., first slot of time interval 0). By way of another example, the alignment of the second CSI reporting configuration 340-b may align the CSI reference resource 335 with a last slot included within the temporally last time interval 345 (e.g., last slot of time interval N₄−1). However, these are provided solely for illustration, and the CSI reference resource 335 may be aligned with (e.g., included within) any slot/TTI of the respective time interval for the CSI reporting configurations 340.

Continuing with reference to FIG. 3, the network entity 105-a may output/transmit, and the UE 115-a may receive, one or more CSI-RSs 315. For example, as shown in FIG. 3, a set of resources 325 may include downlink TTIs 330-a, 330-b, and 330-c. In this example, the UE 115-a may receive CSI-RSs 315 in one or more of the downlink TTIs 330. For example, the UE 115-a may receive a first CSI-RS 315 via the first downlink TTI 330-a, a second CSI-RS 315 via the second downlink TTI 330-b, and a third CSI-RS 315 via the third downlink TTI 330-c. In some implementations, the UE 115-a may additionally or alternatively receive CSI-RSs 315 within the CSI reference resource 335.

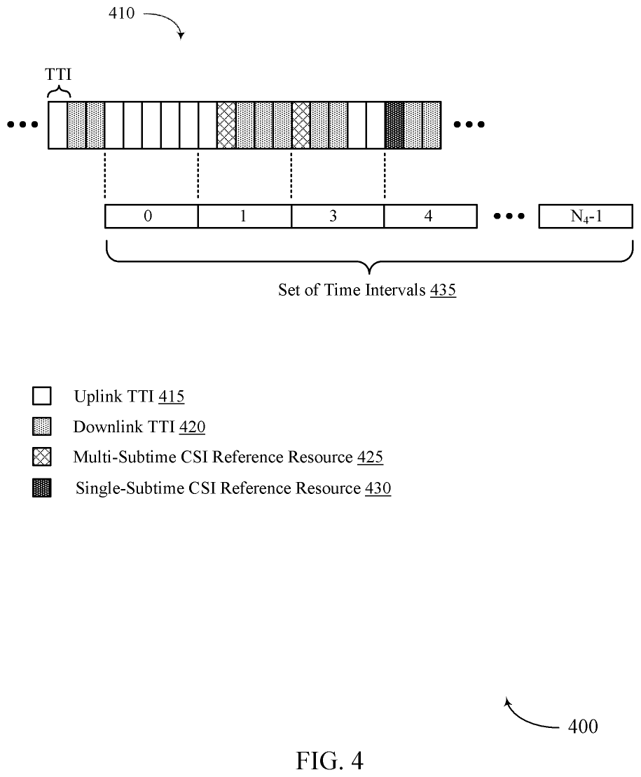

Measurements of CSI-RSs 315 at the UE 115-a will be described in further detail with respect to FIG. 4.

In some aspects, the UE 115-a may perform measurement of, or prediction based on, the received CSI-RSs 315 based on (e.g., in accordance with) the CSI reporting configuration 340 indicated via the control signaling 310. For example, in some cases, the UE 115-a may perform CSI measurements (e.g., CQI measurements) on the CSI-RSs 315 received via the downlink TTIs 330 to measure CSI/CQI within the respective downlink TTIs 330 (and corresponding time intervals 345). Additionally, or alternatively, the UE 115-a may perform measurements on the CSI-RSs 315 received via the downlink TTIs 330 in order to predict or extrapolate CSI/CQI for future time intervals. In other words, the UE 115-a may utilize CSI measurements performed on CSI-RSs 315 received in the downlink TTIs 330 in order to predict or measure channel quality conditions in the future.

The relative association/alignment between the CSI reference resource 335 and the respective time interval 345 may determine whether the UE 115-a is expected to report CSI measurements for time intervals in the past, or report predicted/extrapolated CSI measurements for time intervals in the future for each respective CSI reporting configuration 340. In other words, the alignment of the CSI reporting configuration 340 will determine whether the UE 115-a will report CSI based on measurements performed on CSI-RSs 315, report predicted/extrapolated CSI, or both.

For example, in the context of the first CSI reporting configuration 340-a, the UE 115-a may perform channel prediction/extrapolation based on previous CSI measurements (e.g., CSI measurements performed prior to and/or within the CSI reference resource 335), and may report the predicted/extrapolated CSI via the time-domain CSI report 320. In this example, because the CSI reference resource 335 is aligned with the temporally first time interval 345 (e.g., time interval 0), the time-domain CSI report 320 may include predicted CSI metrics (e.g., PMIs) for the set of time intervals 345-a which are predicted/extrapolated based on CSI measurements performed on CSI-RSs 315 received prior to and/or during the CSI reference resource 335.

In other words, the UE 115-a may perform CSI measurements on CSI-RSs 315 received prior to and/or within the CSI reference resource 335, and may extrapolate/predict CSI for the set of time intervals 345-a in the future based on the performed CSI measurements. In such cases, the CSI report 320 for the first CSI reporting configuration 340-a may indicate the predicted/extrapolated CSI for the time intervals 345-a. For instance, the CSI report 320 may indicate a first predicted CSI measurement (and/or first predicted PMI) for time interval 0, a second predicted CSI measurement (and/or second predicted PMI) for time interval 1, etc. Moreover, because the CSI reference resource 335 is aligned with the temporally first time interval 345 for the first CSI reporting configuration 340-a, the network entity 105-a may be configured to determine that CSI and/or PMIs indicated via the CSI report 320 are associated with time intervals 345 in the future, and are therefore include predicted/extrapolated CSI measurements and predicted/extrapolated PMIs. Further, the network entity 105-a may be able to determine which predicted CSI measurements/predicted PMIs correspond to which time intervals within the set of time intervals 345-a based on the alignment.

By way of another example, in the context of the second CSI reporting configuration 340-b, the UE 115-a may perform CSI measurements and time-domain compression, where the channel prediction/extrapolation is performed by the network entity 105-a. In other words, the CSI report 320 may indicate measured CSI and/or calculated PMIs for the time intervals 345-b which are based on CSI measurements performed within the time intervals 345-b. For instance, the CSI report 320 may indicate a first CSI measurement (and/or first PMI) for time interval 0, a second CSI measurement (and/or second PMI) for time interval 1, etc. Moreover, because the CSI reference resource 335 is aligned with the temporally last time interval 345 for the second CSI reporting configuration 340-b, the network entity 105-a may be configured to determine that CSI and/or PMIs indicated via the CSI report 320 are associated with time intervals 345 in the past, and are therefore include measured CSI. Additionally, the network entity 105-a may predict future CSI for future time intervals based on measured CSI indicated via the CSI report 320. Further, the network entity 105-a may be able to determine which CSI measurements/PMIs correspond to which time intervals within the set of time intervals 345-b based on the alignment.

Comparatively, in the context of the third CSI reporting configuration 340-c, the UE 115-a may perform and report both measured and predicted/extrapolated CSI measurement. In particular, the CSI report 320 transmitted in accordance with the third CSI reporting configuration 340-c may indicate measured CSI for time intervals prior to and/or including the CSI reference resource 335 (e.g., time intervals 0, 1), and may report predicted CSI for time intervals subsequent to the CSI reference resource 335 (e.g., time interval N₄−1). The network entity 105-a may configure what measured CSI (e.g., reported CSI measurements, calculated PMIs) and which predicted CSI (e.g., predicted/extrapolated CSI measurements, predicted/extrapolated PMIs) correspond to which time intervals based on the alignment.

After performing CSI measurements on received CSI-RSs 315 (and/or performing channel prediction/extrapolation) in accordance with the respective CSI reporting configuration 340, the UE 115-a may generate a CSI report 320 and transmit the CSI report 320 to the network entity 105-a. As described previously herein, the CSI report 320 may include measured CSI, predicted/extrapolated CSI, or both. For example, the CSI report 320 transmitted in accordance with the first CSI reporting configuration 340-a may include predicted CSI for the set of time intervals 345-a subsequent to the CSI reference resource 335. Comparatively, the CSI report 320 transmitted in accordance with the second CSI reporting configuration 340-b may include measured CSI for the set of time intervals 345-b prior to the CSI reference resource 335. Finally, the CSI report 320 transmitted in accordance with the third CSI reporting configuration 340-c may include measured CSI for a subset of the set of time intervals 345-c which are prior to the CSI reference resource 335, and predicted CSI for a subset of the set of time intervals 345-c which are subsequent to the CSI reference resource 335.

The CSI report 320 may indicate CSI measurements and/or PMIs associated with the respective time intervals with different formats or granularities. In particular, each subtime/time interval 345 may be associated with multiple subbands, and time-domain CQI may be reported for individual subbands within each time-interval, across multiple subbands of a time interval (e.g., average or median across multiple subbands), and the like.

In some cases, the UE 115-a may perform frequency-time (e.g., subband-subtime, time interval 345-subtime) two-dimensional (2D) differential quantization for multi-subtime (e.g., multi-time interval 345) CQI reporting. In particular, the UE 115-a may be configured to report wideband and sub-time bundle CQI (e.g., C̅Q̅I̅) in accordance with multiple implementations. In accordance with a first implementation for multi-subtime/multi-time interval CQI reporting (e.g., time-domain CQI reporting), the UE 115-a may report time-domain CQI (e.g., CQI measurements) for subband n₃ and subtime n₄ according to CQIₙ_{₃}_{,n}_{₄}=C̅Q̅I̅+δₙ_{₃}_{,n}_{₄} (e.g., direct 2D-differential quantization). The first implementation for differential quantization for CQI reporting is further illustrated in Table 1 below:

TABLE 1
Differential Quantization (Direct 2D-Differential)

Subtime (n₄) →

| | | | | |
|---|---|---|---|---|
| Subband | δₙ_{₃}_{-1,0} | δₙ_{₃}_{-1,1} | . . . | δₙ_{₃}_{-1,n}_{₄}₋₁ |
| (n₃) ↓ | . . . | . . . | | . . . |
| | δ_{1,0} | δ_{1,1} | . . . | δ_{1,n}_{₄}₋₁ |
| | δ_{0,0} | δ_{0,1} | . . . | δ_{0,n}_{₄}₋₁ |

In accordance with a second implementation for multi-subtime/multi-time interval CQI reporting (e.g., time-domain CQI reporting), the UE 115-a may report time-domain CQI (e.g., CQI measurements) for subtime n₄ (CQIₙ_{₄}=C̅Q̅I̅+Δₙ_{₄}), and then for subband n₃ at subtime n₄ (CQIₙ_{₃}_{,n}_{₄}=C̅Q̅I̅ₙ_{₄}+δₙ_{₃}) (e.g., time-differential first). The second implementation for differential quantization for CQI reporting is further illustrated in Table 2 below:

TABLE 2
Differential Quantization (Time-Differential First)

Subtime (n₄) →

| | | | | |
|---|---|---|---|---|
| Subband | Δ₀ + δ_{N}_{₃}₋₁ | Δ₁ + δ_{N}_{₃}₋₁ | . . . | Δ_{N}_{₄}₋₁ + δ_{N}_{₃}₋₁ |
| (n₃) ↓ | . . . | . . . | | |
| | Δ₀ + δ₁ | Δ₁ + δ₁ | . . . | Δ_{N}_{₄}₋₁ + δ₁ |
| | Δ₀ + δ₀ | Δ₁ + δ₀ | . . . | Δ_{N}_{₄}₋₁ + δ₀ |

In accordance with a third implementation for multi-subtime/multi-time interval CQI reporting (e.g., time-domain CQI reporting), the UE 115-a may report time-domain CQI (e.g., CQI measurements) for subband n₃ (CQIₙ_{₃}=C̅Q̅I̅+Δₙ_{₃}) and then for subtime n₄ at subband n₃ (CQIₙ_{₃}_{,n}_{₄}=C̅Q̅I̅ₙ_{₃}+δₙ_{₄}) (e.g., frequency-differential first). The third implementation for differential quantization for CQI reporting is further illustrated in Table 3 below:

TABLE 3
Differential Quantization (Frequency-Differential First)

Subtime (n₄) →

| | | | | |
|---|---|---|---|---|
| Subband | Δ_{N}_{₃}₋₁ + δ₀ | Δ_{N}_{₃}₋₁ + δ₁ | . . . | Δ_{N}_{₃}₋₁ + δ_{N}_{₄}₋₁ |
| (n₃) ↓ | . . . | . . . | | |
| | Δ₁ + δ₀ | Δ₁ + δ₁ | . . . | Δ₁ + δ_{N}_{₄}₋₁ |
| | Δ₀ + δ₀ | Δ₀ + δ₁ | . . . | Δ₀ + δ_{N}_{₄}₋₁ |

Moreover, differential CQI (e.g., Δ or δ) for each of the differential quantization implementations illustrated above (e.g., Tables 1-3) may be interpreted or associated with Table 4 below:

TABLE 4
Mapping of Subband Differential CQI Value to Offset Level

| Subband Differential CQI Value | Offset Level |
|---|---|
| 0 | 0 |
| 1 | 1 |
| 2 | ≥2 |
| 3 | ≤−1 |

Upon receiving the CSI report 320, the network entity 105-a may be configured to evaluate a relative quality of a channel between the UE 115-a and the network entity 105-a based on the time-domain CSI indicated via the CSI report 320. In particular, the CSI report 320 may indicate how the channel between the UE 115-a and the network entity 105-a has (or expected to) change over the respective time intervals 345 associated with the CSI report 320. In some cases, the network entity 105-a may be configured to select and/or selectively adjust communications parameters (e.g., MCS, SCS) used for wireless communications with the UE 115-a based on the reported time-domain CSI (e.g., measured time-domain CSI, predicted/extrapolated CSI).

In some implementations the network entity 105-a may be configured to predict or extrapolate CSI measurements and/or PMIs based on time-domain CSI indicated via the CSI report 320. For example, in the context of the second CSI reporting configuration 340-b, the CSI report 320 may include measured time-domain CSI for the set of time intervals 345-b. In this example, the network entity 105-a may be configured to predict or extrapolate CSI measurements and/or PMIs for time intervals subsequent to the time interval in which the CSI report was received based on the measured time-domain CSI indicated via the CSI report 320. In this regard, the network entity 105-a may be able to predict how channel conditions will change in the future, which may enable the network entity 105-a to schedule and perform wireless communications with the UE 115-a in a more efficient and reliable manner.

Techniques described herein may enable the UE 115-a to report time-domain CSI reports 320, which may provide the network entity 105-a with a more complete and comprehensive picture as to how a relative quality of a channel between the UE 115-a and the network entity 105-a changes over time. In particular, CSI reporting configurations 340 described herein may include or define an alignment between the CSI reference resource 335 and a time interval 345 included within a set of time intervals 345 associated with a time-domain CSI report 320. As such, by defining an alignment between the CSI reference resource 335 and the respective time interval 345, the network entity 105-a may be able to efficiently determine which reported CSI measurements and/or PMIs indicated via the time-domain CSI report 320 correspond to which time intervals 345, thereby enabling the network entity 105-a to determine how the relative channel quality has changed (or is expected to change) over time.

Moreover, techniques described herein may enable the UE 115-a to be configured with different time-domain CSI reporting configurations 340 which cause the UE 115-a to report time-domain CSI (e.g., report changing CSI measurements and/or changing PMIs over time) for time intervals 345 in the past, time intervals 345 in the future, or both. As such, techniques described herein may enable the network entity 105-a to adjust a relative alignment of a CSI reference resources with sets of time intervals 345 reported for CSI to adjust whether the UE 115-a will report measured CSI/calculated PMIs for time intervals 345 in the past, report predicted/expected CSI measurements and PMIs for time intervals 345 in the future, or both.

FIG. 4 illustrates an example of a CSI reporting configuration 400 that supports techniques for time-domain CQI reporting relative to a reference resource in accordance with one or more aspects of the present disclosure. Aspects of the CSI reporting configuration 400 may implement, or be implemented by, aspects of the wireless communications system 100, the CSI reporting configuration 200, the wireless communications system 300, or any combination thereof. In particular, the CSI reporting configuration 400 illustrates CSI reference resources for single and multi-CQI reporting, as described herein.

The CSI reporting configuration 400 illustrates a set of resources 410 including multiple TTIs, which may be an example of the set of resources 325 illustrated in FIG. 3. Each TTI may include a slot or other TTI. Each TTI may include one of an uplink TTI 415, a downlink TTI 420, a downlink reference resource 425 (e.g., multi-subtime CSI reference resource 425), or a CSI reference resource 430 (e.g., single-subtime CSI reference resource 430).

As described previously herein, the CSI reporting configuration 400 may be associated with a set of time intervals 435, where the CSI reporting configuration 400 is associated with an alignment between a single-subtime CSI reference resource 430 and an interval of the set of intervals 435. In other words, the single-subtime CSI reference resource 430 may be positioned within a time interval of the set of time intervals 435 according to the alignment associated with the CSI reporting configuration 400. Each respective time interval 435 may include or span one or more slots or other TTIs. For example, in some cases, each time interval 435 may span five slots.

In some implementations, the single-subtime CSI reference resource 430 may be used for CQI reporting associated with a single subtime (e.g., single time interval). In other words, the single-subtime CSI reference resource 430 may be associated with a single interval of the set of time intervals 435. In such cases, a CSI report may be used to report CSI measurements/PMI for the single time interval (e.g., non-time-domain CSI reporting).

Comparatively, as described in detail herein, the single-subtime CSI reference resource 430 may be used for multi-/multi-time interval) CSI reporting (e.g., time-domain CSI reporting). For example, as described with reference to FIG. 3, a UE 115 may be configured to perform CSI measurements on CSI-RSs received within the respective time intervals 435, and may report time-domain CSI across the set of time intervals 435.

As shown in FIG. 4, each time interval 435 may include zero or some non-zero quantity of downlink TTIs 420. For example, the time interval 0 includes no downlink TTIs 420, whereas time interval 1 includes four downlink TTIs 420 (including the downlink reference resource 425). In other words, each time interval 435 may include varying quantities of downlink candidates in which CSI-RSs may be received and measured. In such cases with varying quantities of candidate TTIs in which CSI-RSs may be received and measured, a UE 115 may implement several different options for measuring CSI in the respective time intervals 435.

For example, if a subtime of the codebook has at least one valid downlink slot (downlink TTI 420), a downlink reference resource (e.g., CSI reference resource) may be defined within the subtime. In such cases, one of the corresponding valid downlink slots (downlink TTIs 420) is defined as the CSI reference resource slot associated with this subtime (e.g., the first or last valid downlink slot within the respective subtime). Stated differently, if a time interval 435 includes one downlink TTI 420 that may be used to receive CSI-RSs, the respective downlink TTI 420 may be designated as the downlink reference resource 425 which will be used to receive a CSI-RS and perform CSI measurements for the respective time interval 435. Moreover, in cases where a time interval 435 includes more than one downlink TTI 420 that may be used to receive CSI-RSs, one of the downlink TTIs 420 within the time interval 435 may be designated as the downlink reference resource 425 (e.g., multi-subtime CSI reference resource 425) which will be used to receive a CSI-RS and perform CSI measurements for the respective time interval 435.

For instance, referring to FIG. 4, time interval 0 includes no downlink TTIs 420 (e.g., no slots within which CSI-RSs may be received and measured). As such, no multi-subtime CSI reference resource 425 may be defined for the time interval 0 (e.g., no CSI reference resource defined for the time interval 0). Comparatively, the time interval 1 includes multiple downlink TTIs 420 which may be used to receive and measure CSI-RSs. In this example, the first downlink TTI 420 may be selected as the multi-subtime CSI reference resource 425 for time interval 1 which will be used to receive and measure CSI-RSs for time interval 1. In additional or alternative implementations, another downlink TTI 420 may be selected as the downlink reference resource 425 for time interval 1 (e.g., last downlink TTI 420 within the time interval 1). In some cases, rules for selecting which downlink TTI 420 will be designated as the multi-subtime CSI reference resource 425 may be signaled to the UE 115, selected by the UE 115, configured at the UE 115, or any combination thereof.

As noted previously herein, CSI reporting configurations described herein (e.g., CSI reporting configuration 400) may enable UEs 115 to report measured time-domain CSI, predicted/extrapolated time-domain CSI, or both. Further, whether reported CSI for a respective time interval 435 includes measured or predicted CSI may be determined based on where the single-subtime CSI reference resource 430 is positioned before, within, or after the respective time interval 435. In some implementations, a UE 115 may be configured to report CSI (e.g., CSI measurements, PMI) only for multi-subtime CSI reference resources 425 which occur no later than the CSI reference resource 430. In such cases, the UE 115 may report CQI measurements performed on CSI-RSs received prior to the CSI reference resource 430, such that the UE 115 does not perform any CQI prediction/extrapolation (e.g., no prediction beyond the single-subtime CSI reference resource 430). In such implementations, CSI reports transmitted by the UE 115 may include time-domain CSI for time intervals prior to (or including) the single-subtime CSI reference resource 430.

Comparatively, in additional or alternative implementations, the UE 115 may be configured to report CSI (e.g., CSI measurements, PMI) for multi-subtime CSI reference resources 425 which both prior to and subsequent to the single-subtime CSI reference resource 430. In other words, in some cases, the CSI reporting configuration 400 may allow CQI reporting posterior the single-subtime CSI reference resource 430, such that the UE 115 performs CQI prediction/extrapolation (e.g., prediction beyond the single-subtime CSI reference resource 430). In such implementations, CSI reports transmitted by the UE 115 may include both time-domain CSI for time intervals prior to (or including) the single-subtime CSI reference resource 430, as well as predicted time-domain CSI for time intervals 435 subsequent to the single-subtime CSI reference resource 430.

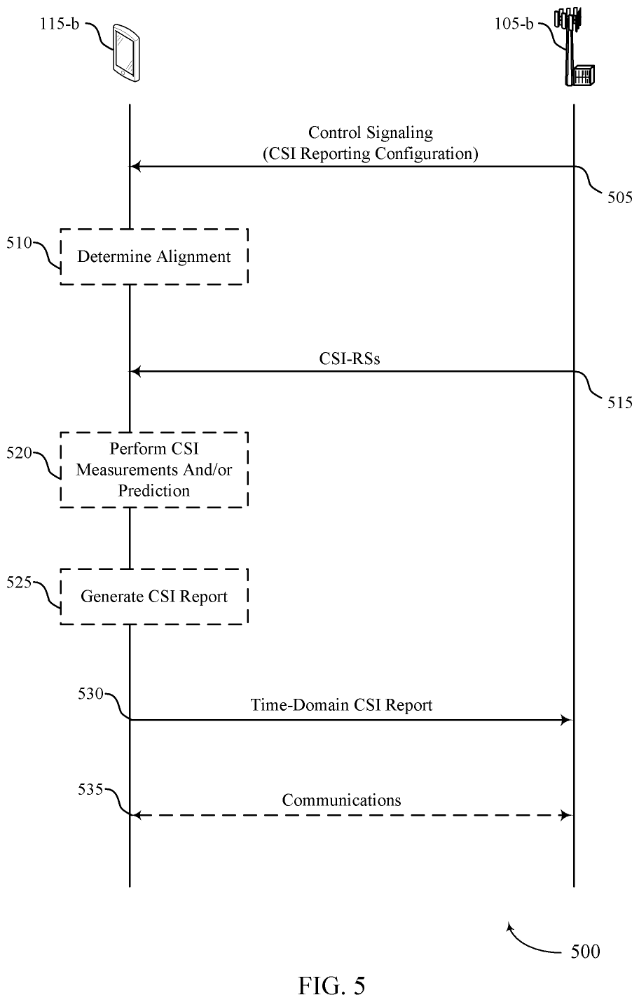

FIG. 5 illustrates an example of a process flow 500 that supports techniques for time-domain CQI reporting relative to a reference resource in accordance with one or more aspects of the present disclosure. In some examples, aspects of the process flow 500 may implement, or be implemented by, aspects of the wireless communications system 100, the CSI reporting configuration 200, the wireless communications system 300, the CSI reporting configuration 400, or any combination thereof. In particular, the process flow 500 illustrates a UE 115-b configured to perform time-domain CSI reporting, as described with reference to FIGS. 1-2, among other aspects.

The process flow 500 may include a UE 115-b and a network entity 105-b, which may be examples of UEs 115 and network entities 105 as described with reference to FIGS. 1-4. For example, the UE 115-b and the network entity 105-b illustrated in FIG. 5 may be examples of the UE 115-a and the network entity 105-a, respectively, as illustrated in FIG. 3.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 505, the network entity 105-b may output (e.g., transmit) control signaling to the UE 115-b, where the control signaling indicates a CSI reporting configuration for time-domain CSI reporting associated with a set of time intervals. In other words, the CSI reporting configuration may cause or instruct the UE 115-b to report time-domain CSI across the set of time intervals. The control signaling may include RRC signaling, DCI signaling, MAC-CE signaling, or any combination thereof.

In some implementations, the CSI reporting configuration may indicate an association between the set of time intervals and a CSI reference resource. In particular, the CSI reporting configuration may be associated with an alignment between the CSI reference resource and a time interval of the set of time intervals such that the CSI reference resource is included within the respective time interval in the time domain. For example, as shown in FIG. 3, the CSI reporting configuration may be associated with an alignment between the CSI reference resource and a temporally first time interval of the set of time intervals, an alignment between the CSI reference resource and a temporally last time interval of the set of time intervals, or an alignment between the CSI reference resource and an Nth time interval of the set of time intervals.

At 510, the UE 115-b may determine or identify an association (e.g., alignment) between the CSI reference resource and the time interval of the set of time intervals associated with the CSI reporting configuration. In some implementations, the UE 115-b may determine the alignment based on (e.g., in accordance with) the CSI reporting configuration indicated via the control signaling at 505. For example, in some cases, the control signaling may indicate the alignment.

In additional or alternative implementations, the UE 115-b may determine or select the alignment without explicit instruction or signaling from the network entity 105-b. In other words, in some implementations, the UE 115-b may be configured to select or determine the alignment autonomously, and may subsequently report the selected alignment to the network entity 105-b, as will be described in further detail herein.

At 515, the network entity 105-b may output (e.g., transmit) one or more CSI-RSs. The network entity 105-b may transmit (and the UE 115-b may receive) the CSI-RSs based on transmitting/receiving the control signaling at 505, determining the alignment at 510, or both. For example, as shown in FIG. 3, the UE 115-a may receive one or more CSI-RSs within downlink TTIs prior to the CSI reference resource, within the CSI reference resource 335, or both.

At 520, the UE 115-b may perform measurements based on the received CSI-RSs, prediction based on the received CSI-RSs, or both. That is, the UE 115-b may be configured to perform CSI measurements on the received CSI-RSs, and may be further configured to perform prediction/extrapolation based on the CSI measurements. In this regard, the UE 115-b may be configured to perform the measurements and/or prediction/extrapolation at 520 based on receiving the control signaling at 505, determining the alignment at 510, receiving the CSI-RSs at 515, or any combination thereof.

In some aspects, as described with reference to FIG. 3, whether the UE 115-b is expected to report measured time-domain CSI and/or predicted time-domain CSI may be based on the respective CSI reporting configuration. For example, in cases where the UE 115-b is configured with the first CSI reporting configuration 340-a illustrated in FIG. 3, the UE 115-b may be configured to report measured time-domain CSI. Comparatively, in cases where the UE 115-b is configured with the second CSI reporting configuration 340-b illustrated in FIG. 3, the UE 115-b may be configured to perform measurements on CSI-RSs received prior to and/or during the CSI reference resource, and determine predicted/extrapolated time-domain CSI based on the performed measurements, where a subsequent CSI report may include the predicted time-domain CSI. Further, in cases where the UE 115-b is configured with the third CSI reporting configuration 340-c illustrated in FIG. 3, the UE 115-b may be configured to report both measured time-domain CSI and predicted time-domain CSI.

In some aspects, time-domain CSI may include measured and/or predicted PMIs. For example, the UE 115-b may be configured to determine/calculate PMIs based on CSI measurements performed at 520. Moreover, the UE 115-b may be configured to determine predicted/extrapolated PMIs based on predicted time-domain CSI.

At 525, the UE 115-b may be configured to generate a time-domain CSI report in accordance with the CSI reporting configuration. The UE 115-b may generate the CSI report at 525 based on performing the measurements and/or prediction at 520. For example, the CSI report may include the time-domain CSI (e.g., measured time-domain CSI, predicted time-domain CSI) which was determined at 520. Moreover, in cases where the UE 115-b determines measured and/or predicted PMIs, the CSI report generated at 525 may include or indicate the measured/predicted PMIs. Further, in cases where the UE 115-b selects the alignment associated with the CSI reporting configuration at 510, the CSI report may indicate the selected alignment.

At 530, the UE 115-b may transmit the time-domain CSI report to the network entity 105-b. In particular, the UE 115-b may transmit (and the network entity 105-b may obtain/receive) the time-domain CSI report at 530 based on transmitting/receiving the control signaling at 505, determining the alignment at 510, receiving/transmitting the CSI-RSs at 515, performing the measurements and/or extrapolation/prediction at 520, generating the CSI report at 525, or any combination thereof.

The CSI report may indicate time-domain CSI (e.g., measured time-domain CSI, predicted time-domain CSI) for the set of time intervals associated with the CSI reporting configuration. As noted previously herein, the type of time-domain CSI indicated via the time-domain CSI report (e.g., whether the CSI report includes measured time-domain CSI, predicted time-domain CSI, or both) may be based on the alignment associated with the CSI reporting configuration.

At 535, the UE 115-b and the network entity 105-b may communicate with one another based on the time-domain CSI report at 530. In particular, the network entity 105-b may determine and/or selectively modify one or more parameters used for wireless communications between the UE 115-b and the network entity 105-b based on the CSI report. For example, the network entity 105-b and the UE 115-b may communicate with one another at 535 using one or more precoding matrices associated with PMIs indicated via the CSI report.

Techniques described herein may enable the UE 115-b to report time-domain CSI reports, which may provide the network entity 105-b with a more complete and comprehensive picture as to how a relative quality of a channel between the UE 115-b and the network entity 105-b changes over time. In particular, CSI reporting configurations described herein may include or define an alignment between the CSI reference resource and a time interval included within a set of time intervals associated with a time-domain CSI report. As such, by defining an alignment between the CSI reference resource and the respective time interval, the network entity 105-b may be able to efficiently determine which reported CSI measurements and/or PMIs indicated via the time-domain CSI report correspond to which time intervals, thereby enabling the network entity 105-b to determine how the relative channel quality has changed (or is expected to change) over time.

Moreover, techniques described herein may enable the UE 115-b to be configured with different time-domain CSI reporting configurations which cause the UE 115-b to report time-domain CSI (e.g., report changing CSI measurements and/or changing PMIs over time) for time intervals in the past, time intervals in the future, or both. As such, techniques described herein may enable the network entity 105-b to adjust a relative alignment of a CSI reference resources with sets of time intervals reported for CSI to adjust whether the UE 115-b will report measured CSI/calculated PMIs for time intervals in the past, report predicted/expected CSI measurements and PMIs for time intervals in the future, or both.

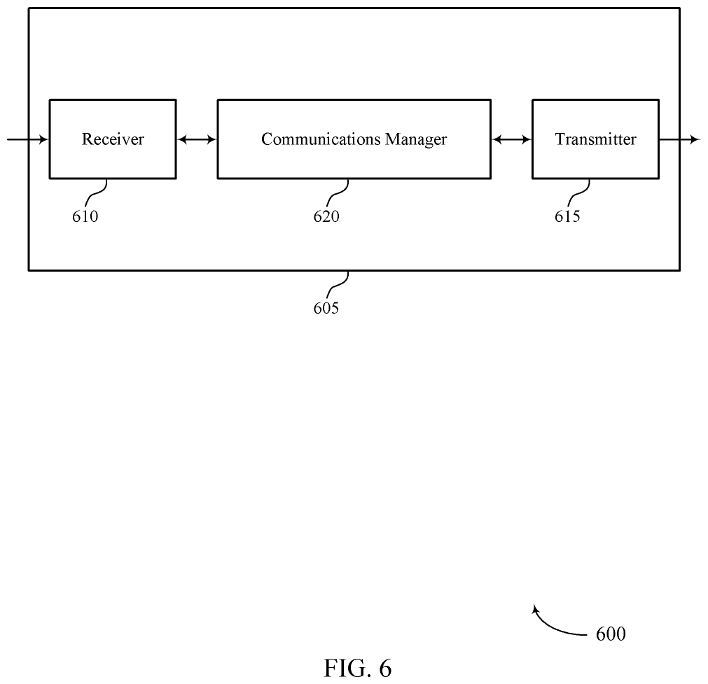

FIG. 6 shows a block diagram 600 of a device 605 that supports techniques for time-domain channel quality information reporting relative to reference resource in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for time-domain channel quality information reporting relative to reference resource). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for time-domain channel quality information reporting relative to reference resource). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for time-domain channel quality information reporting relative to reference resource as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The communications manager 620 may be configured as or otherwise support a means for transmitting, to the network entity and based on the CSI reporting configuration, a time-domain CSI report indicating time-domain CSI, predicted time-domain CSI, or both, associated with the set of multiple time intervals.

By including or configuring the communications manager 620 in accordance with examples as described herein, the device 605 (e.g., a processor controlling or otherwise coupled with the receiver 610, the transmitter 615, the communications manager 620, or a combination thereof) may support techniques which enable UEs 115 to report time-domain CSI reports, which may provide the network with a more complete and comprehensive picture as to how a relative quality of a channel between the UEs 115 and the network changes over time. In particular, CSI reporting configurations described herein may include or define an alignment between the CSI reference resource and a time interval included within a set of time intervals associated with a time-domain CSI report. As such, by defining an alignment between the CSI reference resource and the respective time interval, the network may be able to efficiently determine which reported CSI measurements and/or PMIs indicated via the time-domain CSI report correspond to which time intervals, thereby enabling the network to determine how the relative channel quality has changed (or is expected to change) over time.

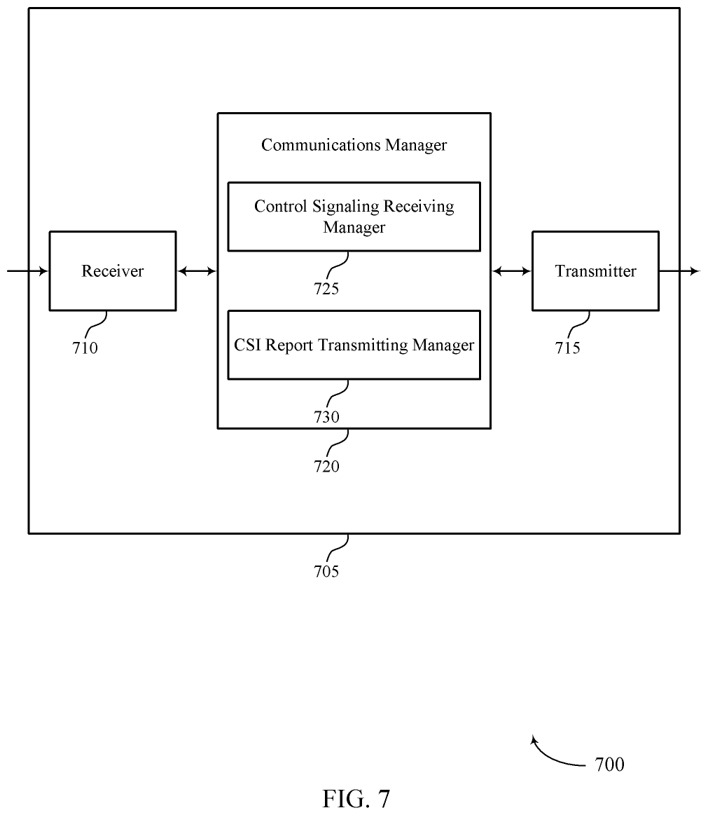

FIG. 7 shows a block diagram 700 of a device 705 that supports techniques for time-domain channel quality information reporting relative to reference resource in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for time-domain channel quality information reporting relative to reference resource). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for time-domain channel quality information reporting relative to reference resource). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for time-domain channel quality information reporting relative to reference resource as described herein. For example, the communications manager 720 may include a control signaling receiving manager 725 a CSI report transmitting manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The control signaling receiving manager 725 may be configured as or otherwise support a means for receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The CSI report transmitting manager 730 may be configured as or otherwise support a means for transmitting, to the network entity and based on the CSI reporting configuration, a time-domain CSI report indicating time-domain CSI, predicted time-domain CSI, or both, associated with the set of multiple time intervals.

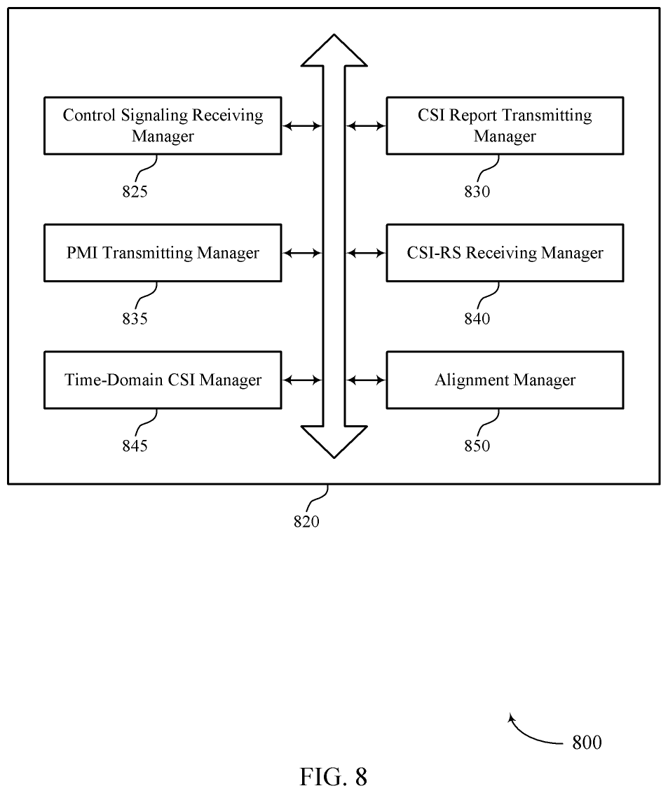

FIG. 8 shows a block diagram 800 of a communications manager 820 that supports techniques for time-domain channel quality information reporting relative to reference resource in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for time-domain channel quality information reporting relative to reference resource as described herein. For example, the communications manager 820 may include a control signaling receiving manager 825, a CSI report transmitting manager 830, a PMI transmitting manager 835, a CSI-RS receiving manager 840, a time-domain CSI manager 845, an alignment manager 850, or any combination thereof. Each of these components may communicate, directly or indirectly, with one another (e.g., via one or more buses).

The communications manager 820 may support wireless communication at a UE in accordance with examples as disclosed herein. The control signaling receiving manager 825 may be configured as or otherwise support a means for receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The CSI report transmitting manager 830 may be configured as or otherwise support a means for transmitting, to the network entity and based on the CSI reporting configuration, a time-domain CSI report indicating time-domain CSI, predicted time-domain CSI, or both, associated with the set of multiple time intervals.

In some examples, the PMI transmitting manager 835 may be configured as or otherwise support a means for transmitting, via the time-domain CSI report, one or more PMIs associated with the set of multiple time intervals, where the one or more PMIs are based on the time-domain CSI.

In some examples, the CSI-RS receiving manager 840 may be configured as or otherwise support a means for performing measurement of, prediction based on, or both, one or more CSI-RSs in accordance with the CSI reporting configuration. In some examples, the CSI report transmitting manager 830 may be configured as or otherwise support a means for transmitting, via the time-domain CSI report, an indication of measured time-domain CSI, predicted time-domain CSI, or both, associated with the set of multiple time intervals, where the measured time-domain CSI, the predicted time-domain CSI, or both, is based on the performing.

In some examples, the CSI reporting configuration is associated with an alignment between the CSI reference resource and a temporally first time interval of the set of multiple time intervals, and the time-domain CSI manager 845 may be configured as or otherwise support a means for determining the predicted time-domain CSI based on the measurement of the one or more CSI-RSs received within the temporally first time interval, within the CSI reference resource, or both, where the time-domain CSI report includes the predicted time-domain CSI.

In some examples, the CSI reporting configuration is associated with an alignment between the CSI reference resource and a temporally last time interval of the set of multiple time intervals, and the time-domain CSI manager 845 may be configured as or otherwise support a means for determining measured time-domain CSI based on the measurement of the one or more CSI-RSs received prior to the CSI reference resource and during the set of multiple time intervals, where the time-domain CSI includes the measured time-domain CSI.

In some examples, the CSI reporting configuration is associated with an alignment between the CSI reference resource and an indicated time interval of the set of multiple time intervals, and the time-domain CSI manager 845 may be configured as or otherwise support a means for determining measured time-domain CSI associated with a first subset of the set of multiple time intervals prior to the indicated time interval based on the measurement of the one or more CSI-RSs received prior to the CSI reference resource and during the first subset of the set of multiple time intervals. In some examples, the CSI reporting configuration is associated with an alignment between the CSI reference resource and an indicated time interval of the set of multiple time intervals, and the time-domain CSI manager 845 may be configured as or otherwise support a means for determining predicted time-domain CSI associated with a second subset of the set of multiple time intervals subsequent to the indicated time interval based on the measurement of the one or more CSI-RSs received prior to the CSI reference resource and during the first subset of the set of multiple time intervals, where the time-domain CSI includes the measured time-domain CSI associated with the first subset of time intervals and the predicted time-domain CSI associated with the second subset of time intervals.

In some examples, the alignment manager 850 may be configured as or otherwise support a means for determining an alignment between a time interval of the set of multiple time intervals and the CSI reference resource based on the CSI reporting configuration. In some examples, the CSI report transmitting manager 830 may be configured as or otherwise support a means for transmitting, via the time-domain CSI report, an indication of the determined alignment.

In some examples, the CSI reporting configuration is associated with a set of multiple CSI resources within the set of multiple time intervals. In some examples, the time-domain CSI is associated with one or more time intervals of the set of multiple time intervals that include at least one CSI resource from the set of multiple CSI resources.

In some examples, a time interval of the set of multiple time intervals includes a set of one or more CSI resources. In some examples, the time-domain CSI indicated via the time-domain CSI report is based on at least one of the one or more CSI resources. In some examples, the time-domain CSI report is associated with at least a first time interval of the set of multiple time intervals. In some examples, the time-domain CSI is associated with an identified subband of the first time interval, a set of multiple subbands of the first time interval, or both.

In some examples, the CSI reporting configuration is associated with an alignment between the CSI reference resource and a temporally first slot of a time interval of the set of multiple time intervals, or an alignment between the CSI reference resource and a temporally last slot of the time interval of the set of multiple time intervals. In some examples, the CSI reference resource is associated with a single time interval of the set of multiple time intervals. In some examples, the time-domain CSI is associated with the single time interval.

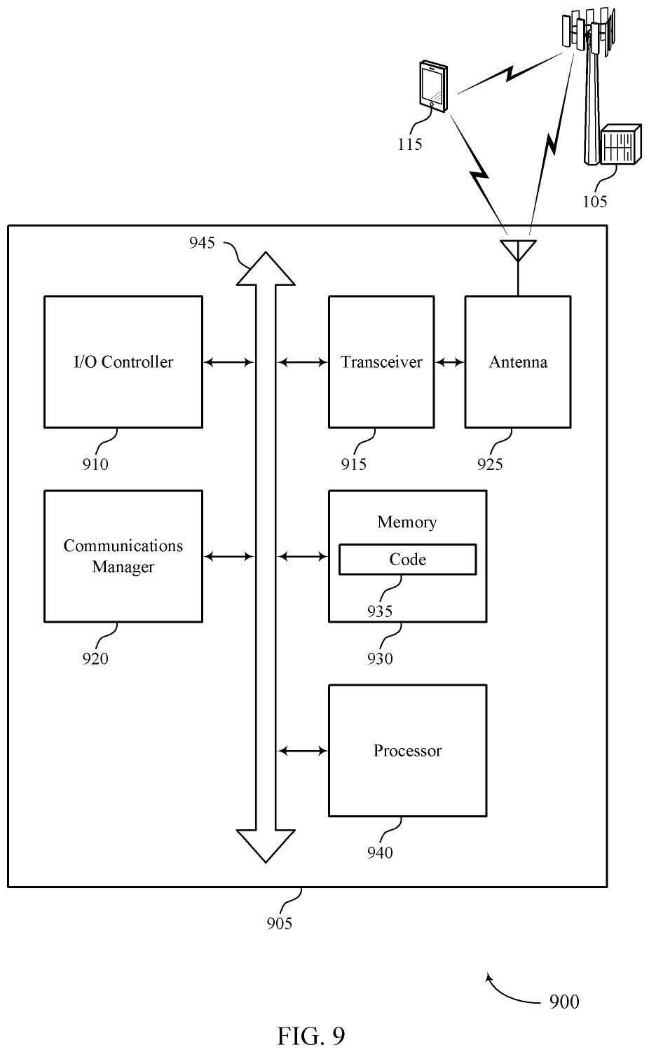

FIG. 9 shows a diagram of a system 900 including a device 905 that supports techniques for time-domain channel quality information reporting relative to reference resource in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for time-domain channel quality information reporting relative to reference resource). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The communications manager 920 may be configured as or otherwise support a means for transmitting, to the network entity and based on the CSI reporting configuration, a time-domain CSI report indicating time-domain CSI, predicted time-domain CSI, or both, associated with the set of multiple time intervals.

By including or configuring the communications manager 920 in accordance with examples as described herein, the device 905 may support techniques which enable UEs 115 to report time-domain CSI reports, which may provide the network with a more complete and comprehensive picture as to how a relative quality of a channel between the UEs 115 and the network changes over time. In particular, CSI reporting configurations described herein may include or define an alignment between the CSI reference resource and a time interval included within a set of time intervals associated with a time-domain CSI report. As such, by defining an alignment between the CSI reference resource and the respective time interval, the network may be able to efficiently determine which reported CSI measurements and/or PMIs indicated via the time-domain CSI report correspond to which time intervals, thereby enabling the network to determine how the relative channel quality has changed (or is expected to change) over time.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for time-domain channel quality information reporting relative to reference resource as described herein, or the processor 940 and the memory 930 may be otherwise configured to perform or support such operations.

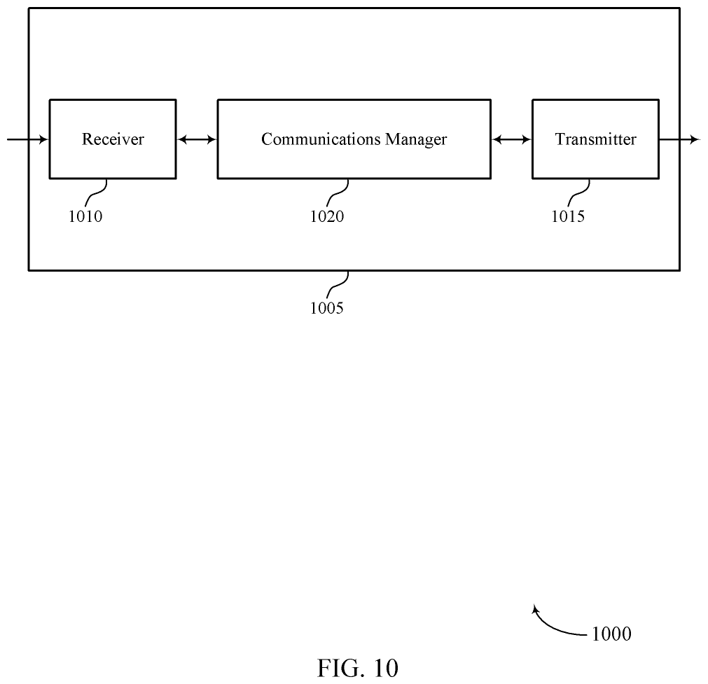

FIG. 10 shows a block diagram 1000 of a device 1005 that supports techniques for time-domain channel quality information reporting relative to reference resource in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for time-domain channel quality information reporting relative to reference resource as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The communications manager 1020 may be configured as or otherwise support a means for transmitting one or more CSI-RSs in accordance with the CSI reporting configuration. The communications manager 1020 may be configured as or otherwise support a means for receiving, from the UE and based on the transmitting the one or more CSI-RSs, a time-domain CSI report indicating time-domain CSI associated with the set of multiple time intervals.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques which enable UEs 115 to report time-domain CSI reports, which may provide the network with a more complete and comprehensive picture as to how a relative quality of a channel between the UEs 115 and the network changes over time. In particular, CSI reporting configurations described herein may include or define an alignment between the CSI reference resource and a time interval included within a set of time intervals associated with a time-domain CSI report. As such, by defining an alignment between the CSI reference resource and the respective time interval, the network may be able to efficiently determine which reported CSI measurements and/or PMIs indicated via the time-domain CSI report correspond to which time intervals, thereby enabling the network to determine how the relative channel quality has changed (or is expected to change) over time.

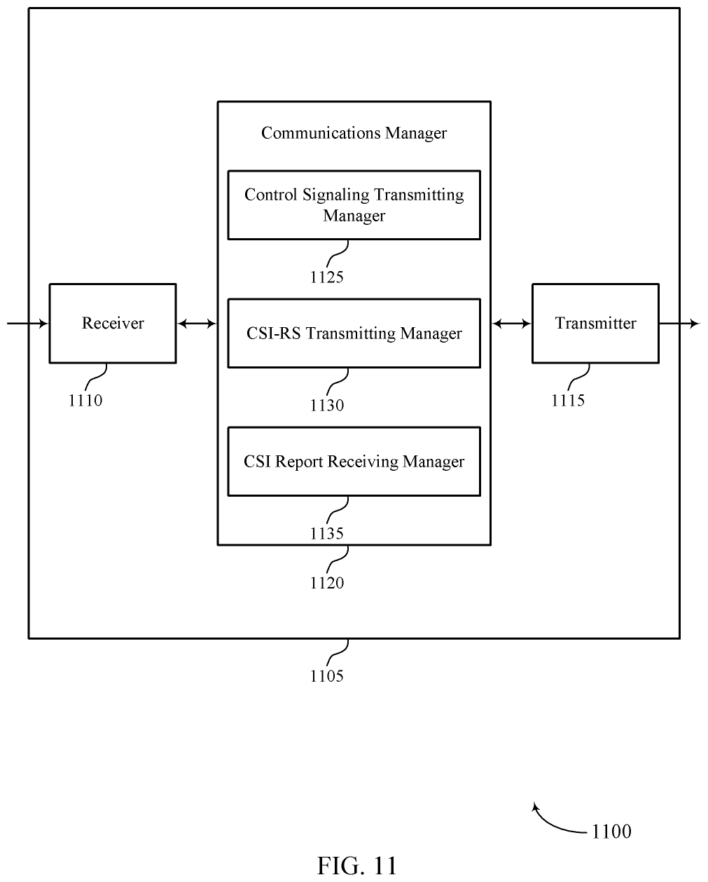

FIG. 11 shows a block diagram 1100 of a device 1105 that supports techniques for time-domain channel quality information reporting relative to reference resource in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for time-domain channel quality information reporting relative to reference resource as described herein. For example, the communications manager 1120 may include a control signaling transmitting manager 1125, a CSI-RS transmitting manager 1130, a CSI report receiving manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The control signaling transmitting manager 1125 may be configured as or otherwise support a means for transmitting, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The CSI-RS transmitting manager 1130 may be configured as or otherwise support a means for transmitting one or more CSI-RSs in accordance with the CSI reporting configuration. The CSI report receiving manager 1135 may be configured as or otherwise support a means for receiving, from the UE and based on the transmitting the one or more CSI-RSs, a time-domain CSI report indicating time-domain CSI associated with the set of multiple time intervals.

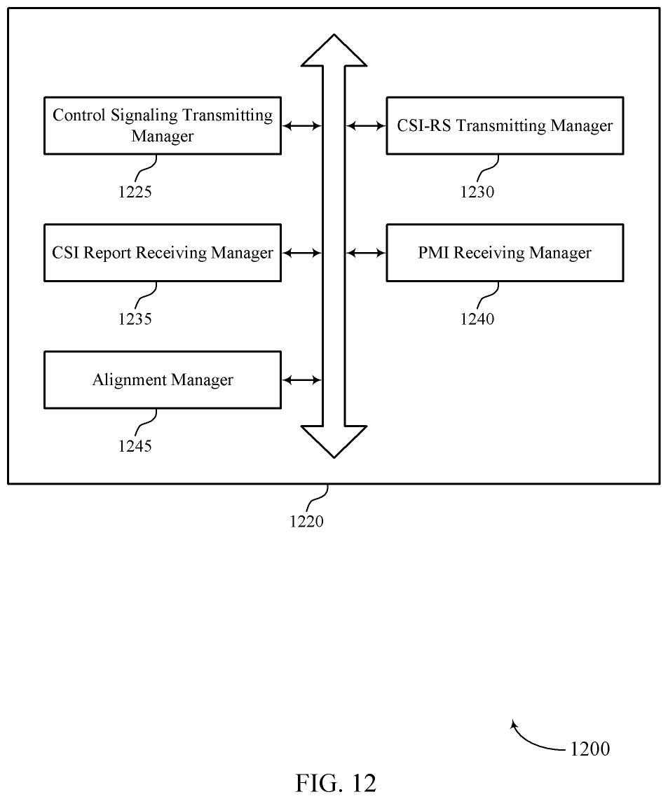

FIG. 12 shows a block diagram 1200 of a communications manager 1220 that supports techniques for time-domain channel quality information reporting relative to reference resource in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for time-domain channel quality information reporting relative to reference resource as described herein. For example, the communications manager 1220 may include a control signaling transmitting manager 1225, a CSI-RS transmitting manager 1230, a CSI report receiving manager 1235, a PMI receiving manager 1240, an alignment manager 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The control signaling transmitting manager 1225 may be configured as or otherwise support a means for transmitting, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The CSI-RS transmitting manager 1230 may be configured as or otherwise support a means for transmitting one or more CSI-RSs in accordance with the CSI reporting configuration. The CSI report receiving manager 1235 may be configured as or otherwise support a means for receiving, from the UE and based on the transmitting the one or more CSI-RSs, a time-domain CSI report indicating time-domain CSI associated with the set of multiple time intervals.

In some examples, the PMI receiving manager 1240 may be configured as or otherwise support a means for receiving, via the time-domain CSI report, one or more PMIs associated with the set of multiple time intervals, where the one or more PMIs based on the measured time-domain CSI, the predicted time-domain CSI, or both.

In some examples, the CSI reporting configuration is associated with an alignment between the CSI reference resource and a temporally first time interval of the set of multiple time intervals. In some examples, the predicted time-domain CSI is based on the one or more CSI-RSs transmitted within the temporally first time interval, within the CSI reference resource, or both. In some examples, the time-domain CSI report includes the predicted time-domain CSI.

In some examples, the CSI reporting configuration is associated with an alignment between the CSI reference resource and a temporally last time interval of the set of multiple time intervals. In some examples, the measured time-domain CSI is based on the one or more CSI-RSs transmitted prior to the CSI reference resource and during the set of multiple time intervals. In some examples, the time-domain CSI report includes the measured time-domain CSI.

In some examples, the CSI reporting configuration is associated with an alignment between the CSI reference resource and an indicated time interval of the set of multiple time intervals. In some examples, the measured time-domain CSI is associated with a first subset of the set of multiple time intervals prior to the indicated time interval based on the one or more CSI-RSs transmitted prior to the CSI reference resource and during the first subset of the set of multiple time intervals. In some examples, the predicted time-domain CSI is associated with a second subset of the set of multiple time intervals subsequent to the indicated time interval based on the one or more CSI-RSs transmitted prior to the CSI reference resource and during the first subset of the set of multiple time intervals. In some examples, the time-domain CSI report includes the measured time-domain CSI associated with the first subset of time intervals and the predicted time-domain CSI associated with the second subset of time intervals.

In some examples, the alignment manager 1245 may be configured as or otherwise support a means for receiving, via the time-domain CSI report, an indication of an alignment between a time interval of the set of multiple time intervals and the CSI reference resource based on the CSI reporting configuration.

In some examples, the CSI reporting configuration is associated with a set of multiple CSI resources within the set of multiple time intervals. In some examples, the measured time-domain CSI is associated with one or more time intervals of the set of multiple time intervals that include at least one CSI resource from the set of multiple CSI resources.

In some examples, a time interval of the set of multiple time intervals includes a set of one or more CSI resources. In some examples, the measured time-domain CSI indicated via the time-domain CSI report is based on at least one of the one or more CSI resources.

In some examples, the time-domain CSI report is associated with at least a first time interval of the set of multiple time intervals. In some examples, the measured time-domain CSI, the predicted time-domain CSI, or both, is associated with an identified subband of the first time interval, a set of multiple subbands of the first time interval, or both.

In some examples, the CSI reporting configuration is associated with an alignment between the CSI reference resource and a temporally first slot of a time interval of the set of multiple time intervals, or an alignment between the CSI reference resource and a temporally last slot of the time interval of the set of multiple time intervals.

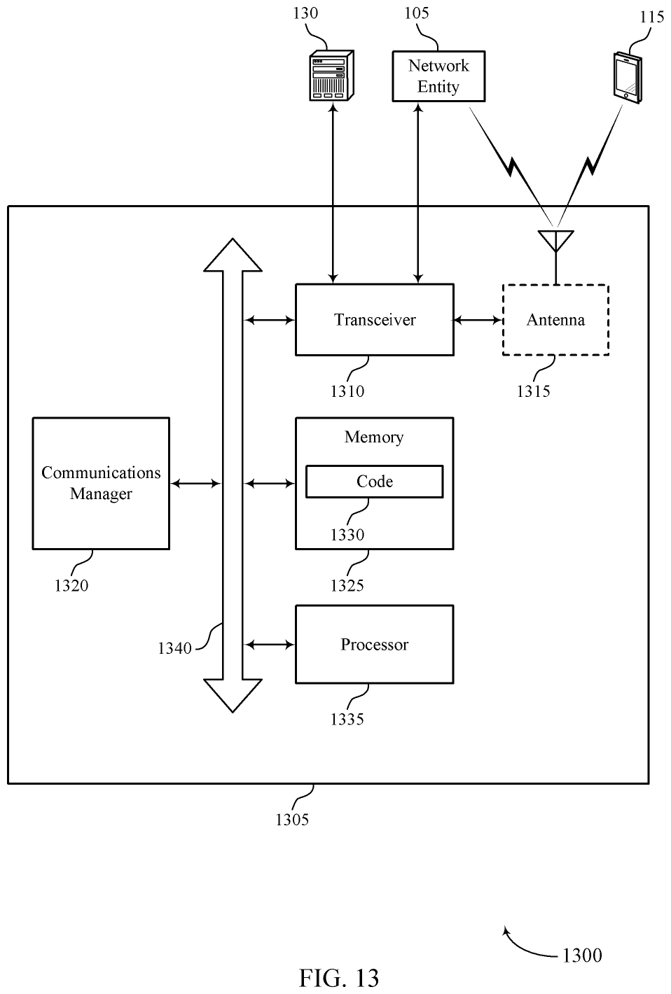

FIG. 13 shows a diagram of a system 1300 including a device 1305 that supports techniques for time-domain channel quality information reporting relative to reference resource in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for time-domain channel quality information reporting relative to reference resource). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The communications manager 1320 may be configured as or otherwise support a means for transmitting one or more CSI-RSs in accordance with the CSI reporting configuration. The communications manager 1320 may be configured as or otherwise support a means for receiving, from the UE and based on the transmitting the one or more CSI-RSs, a time-domain CSI report indicating time-domain CSI associated with the set of multiple time intervals.

By including or configuring the communications manager 1320 in accordance with examples as described herein, the device 1305 may support techniques which enable UEs 115 to report time-domain CSI reports, which may provide the network with a more complete and comprehensive picture as to how a relative quality of a channel between the UEs 115 and the network changes over time. In particular, CSI reporting configurations described herein may include or define an alignment between the CSI reference resource and a time interval included within a set of time intervals associated with a time-domain CSI report. As such, by defining an alignment between the CSI reference resource and the respective time interval, the network may be able to efficiently determine which reported CSI measurements and/or PMIs indicated via the time-domain CSI report correspond to which time intervals, thereby enabling the network to determine how the relative channel quality has changed (or is expected to change) over time.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of techniques for time-domain channel quality information reporting relative to reference resource as described herein, or the processor 1335 and the memory 1325 may be otherwise configured to perform or support such operations.

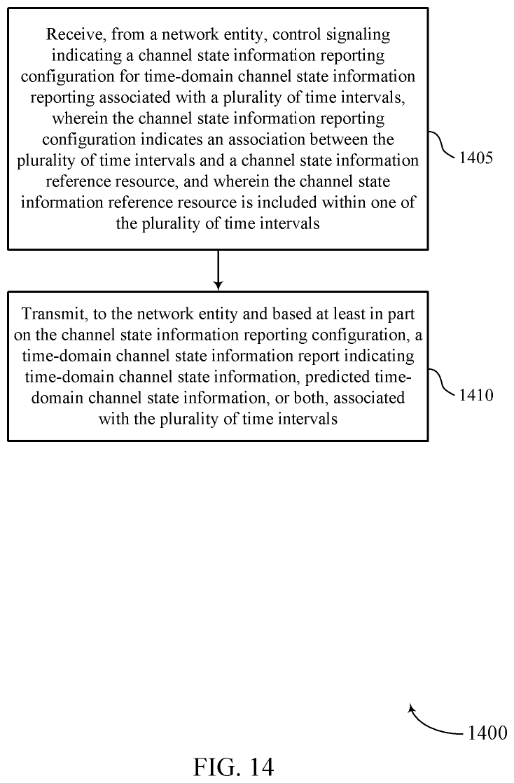

FIG. 14 shows a flowchart illustrating a method 1400 that supports techniques for time-domain channel quality information reporting relative to reference resource in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The operations of 1405 may be performed in accordance with examples as disclosed herein. In some examples, aspects of the operations of 1405 may be performed by a control signaling receiving manager 825 as described with reference to FIG. 8.

At 1410, the method may include transmitting, to the network entity and based on the CSI reporting configuration, a time-domain CSI report indicating time-domain CSI, predicted time-domain CSI, or both, associated with the set of multiple time intervals. The operations of 1410 may be performed in accordance with examples as disclosed herein. In some examples, aspects of the operations of 1410 may be performed by a CSI report transmitting manager 830 as described with reference to FIG. 8.

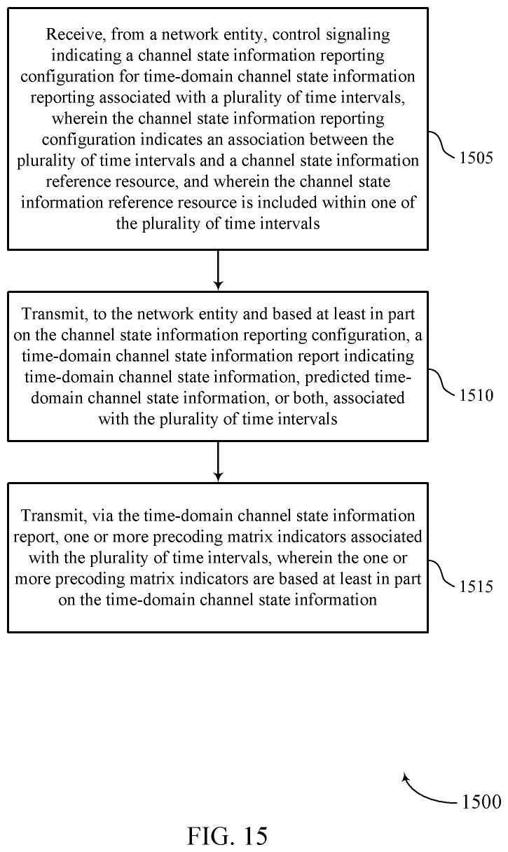

FIG. 15 shows a flowchart illustrating a method 1500 that supports techniques for time-domain channel quality information reporting relative to reference resource in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The operations of 1505 may be performed in accordance with examples as disclosed herein. In some examples, aspects of the operations of 1505 may be performed by a control signaling receiving manager 825 as described with reference to FIG. 8.

At 1510, the method may include transmitting, to the network entity and based on the CSI reporting configuration, a time-domain CSI report indicating time-domain CSI, predicted time-domain CSI, or both, associated with the set of multiple time intervals. The operations of 1510 may be performed in accordance with examples as disclosed herein. In some examples, aspects of the operations of 1510 may be performed by a CSI report transmitting manager 830 as described with reference to FIG. 8.

At 1515, the method may include transmitting, via the time-domain CSI report, one or more PMIs associated with the set of multiple time intervals, where the one or more PMIs are based on the time-domain CSI. The operations of 1515 may be performed in accordance with examples as disclosed herein. In some examples, aspects of the operations of 1515 may be performed by a PMI transmitting manager 835 as described with reference to FIG. 8.

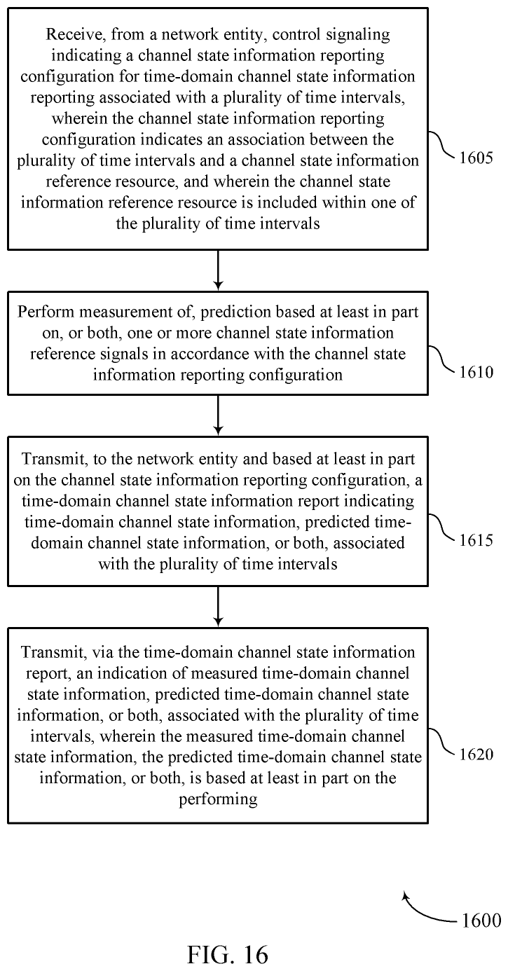

FIG. 16 shows a flowchart illustrating a method 1600 that supports techniques for time-domain channel quality information reporting relative to reference resource in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The operations of 1605 may be performed in accordance with examples as disclosed herein. In some examples, aspects of the operations of 1605 may be performed by a control signaling receiving manager 825 as described with reference to FIG. 8.

At 1610, the method may include performing measurement of, prediction based on, or both, one or more CSI-RSs in accordance with the CSI reporting configuration. The operations of 1610 may be performed in accordance with examples as disclosed herein. In some examples, aspects of the operations of 1610 may be performed by a CSI-RS receiving manager 840 as described with reference to FIG. 8.

At 1615, the method may include transmitting, to the network entity and based on the CSI reporting configuration, a time-domain CSI report indicating time-domain CSI, predicted time-domain CSI, or both, associated with the set of multiple time intervals. The operations of 1615 may be performed in accordance with examples as disclosed herein. In some examples, aspects of the operations of 1615 may be performed by a CSI report transmitting manager 830 as described with reference to FIG. 8.

At 1620, the method may include transmitting, via the time-domain CSI report, an indication of measured time-domain CSI, predicted time-domain CSI, or both, associated with the set of multiple time intervals, where the measured time-domain CSI, the predicted time-domain CSI, or both, is based on the performing. The operations of 1620 may be performed in accordance with examples as disclosed herein. In some examples, aspects of the operations of 1620 may be performed by a CSI report transmitting manager 830 as described with reference to FIG. 8.

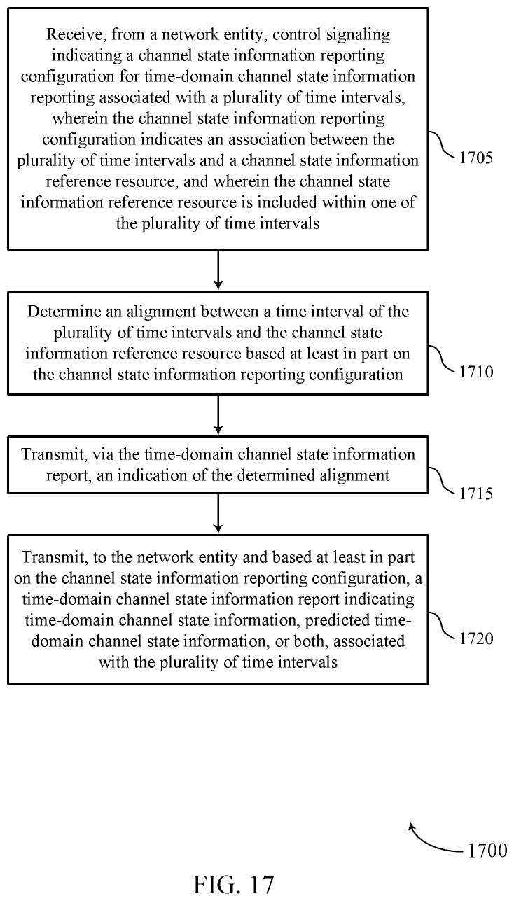

FIG. 17 shows a flowchart illustrating a method 1700 that supports techniques for time-domain channel quality information reporting relative to reference resource in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The operations of 1705 may be performed in accordance with examples as disclosed herein. In some examples, aspects of the operations of 1705 may be performed by a control signaling receiving manager 825 as described with reference to FIG. 8.

At 1710, the method may include determining an alignment between a time interval of the set of multiple time intervals and the CSI reference resource based on the CSI reporting configuration. The operations of 1710 may be performed in accordance with examples as disclosed herein. In some examples, aspects of the operations of 1710 may be performed by an alignment manager 850 as described with reference to FIG. 8.

At 1715, the method may include transmitting, to the network entity and based on the CSI reporting configuration, a time-domain CSI report indicating time-domain CSI, predicted time-domain CSI, or both, associated with the set of multiple time intervals. The operations of 1715 may be performed in accordance with examples as disclosed herein. In some examples, aspects of the operations of 1715 may be performed by a CSI report transmitting manager 830 as described with reference to FIG. 8.

At 1720, the method may include transmitting, via the time-domain CSI report, an indication of the determined alignment. The operations of 1720 may be performed in accordance with examples as disclosed herein. In some examples, aspects of the operations of 1720 may be performed by a CSI report transmitting manager 830 as described with reference to FIG. 8.

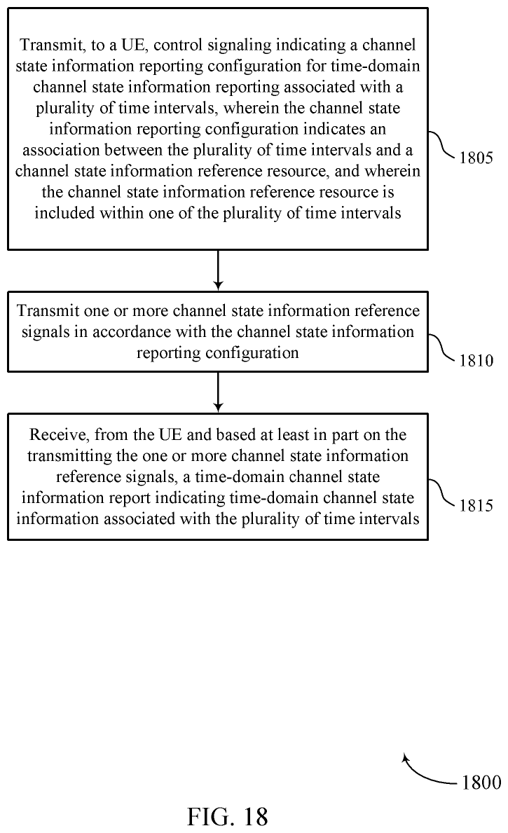

FIG. 18 shows a flowchart illustrating a method 1800 that supports techniques for time-domain channel quality information reporting relative to reference resource in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, control signaling indicating a CSI reporting configuration for time-domain CSI reporting associated with a set of multiple time intervals, where the CSI reporting configuration indicates an association between the set of multiple time intervals and a CSI reference resource, and where the CSI reference resource is included within one of the set of multiple time intervals. The operations of 1805 may be performed in accordance with examples as disclosed herein. In some examples, aspects of the operations of 1805 may be performed by a control signaling transmitting manager 1225 as described with reference to FIG. 12.

At 1810, the method may include transmitting one or more CSI-RSs in accordance with the CSI reporting configuration. The operations of 1810 may be performed in accordance with examples as disclosed herein. In some examples, aspects of the operations of 1810 may be performed by a CSI-RS transmitting manager 1230 as described with reference to FIG. 12.

At 1815, the method may include receiving, from the UE and based on the transmitting the one or more CSI-RSs, a time-domain CSI report indicating time-domain CSI associated with the set of multiple time intervals. The operations of 1815 may be performed in accordance with examples as disclosed herein. In some examples, aspects of the operations of 1815 may be performed by a CSI report receiving manager 1235 as described with reference to FIG. 12.

The following provides an overview of aspects of the present disclosure:

Aspect 1: A method for wireless communication at a UE, comprising: receiving, from a network entity, control signaling indicating a CSI reporting configuration for time-domain CSI reporting associated with a plurality of time intervals, wherein the CSI reporting configuration indicates an association between the plurality of time intervals and a CSI reference resource, and wherein the CSI reference resource is included within one of the plurality of time intervals; and transmitting, to the network entity and based at least in part on the CSI reporting configuration, a time-domain CSI report indicating time-domain CSI, predicted time-domain CSI, or both, associated with the plurality of time intervals.

Aspect 2: The method of aspect 1, further comprising: transmitting, via the time-domain CSI report, one or more PMIs associated with the plurality of time intervals, wherein the one or more PMIs are based at least in part on the time-domain CSI.

Aspect 3: The method of any of aspects 1 through 2, further comprising: performing measurement of, prediction based at least in part on, or both, one or more CSI-RSs in accordance with the CSI reporting configuration; and transmitting, via the time-domain CSI report, an indication of measured time-domain CSI, predicted time-domain CSI, or both, associated with the plurality of time intervals, wherein the measured time-domain CSI, the predicted time-domain CSI, or both, is based at least in part on the performing.

Aspect 4: The method of any of aspects 1 through 3, wherein the CSI reporting configuration is associated with an alignment between the CSI reference resource and a temporally first time interval of the plurality of time intervals, the method further comprising: determining the predicted time-domain CSI based at least in part on the measurement of the one or more CSI-RSs received within the temporally first time interval, within the CSI reference resource, or both, wherein the time-domain CSI report comprises the predicted time-domain CSI.

Aspect 5: The method of any of aspects 1 through 4, wherein the CSI reporting configuration is associated with an alignment between the CSI reference resource and a temporally last time interval of the plurality of time intervals, the method further comprising: determining measured time-domain CSI based at least in part on the measurement of the one or more CSI-RSs received prior to the CSI reference resource and during the plurality of time intervals, wherein the time-domain CSI comprises the measured time-domain CSI.

Aspect 6: The method of any of aspects 1 through 5, wherein the CSI reporting configuration is associated with an alignment between the CSI reference resource and an indicated time interval of the plurality of time intervals, the method further comprising: determining measured time-domain CSI associated with a first subset of the plurality of time intervals prior to the indicated time interval based at least in part on the measurement of the one or more CSI-RSs received prior to the CSI reference resource and during the first subset of the plurality of time intervals; and determining predicted time-domain CSI associated with a second subset of the plurality of time intervals subsequent to the indicated time interval based at least in part on the measurement of the one or more CSI-RSs received prior to the CSI reference resource and during the first subset of the plurality of time intervals, wherein the time-domain CSI comprises the measured time-domain CSI associated with the first subset of time intervals and the predicted time-domain CSI associated with the second subset of time intervals.

Aspect 7: The method of any of aspects 1 through 6, further comprising: determining an alignment between a time interval of the plurality of time intervals and the CSI reference resource based at least in part on the CSI reporting configuration; and transmitting, via the time-domain CSI report, an indication of the determined alignment.

Aspect 8: The method of any of aspects 1 through 7, wherein the CSI reporting configuration is associated with a plurality of CSI reference resources within the plurality of time intervals, and the time-domain CSI is associated with one or more time intervals of the plurality of time intervals that include at least one CSI reference resource from the plurality of CSI reference resources.

Aspect 9: The method of any of aspects 1 through 8, wherein a time interval of the plurality of time intervals comprises a set of one or more CSI reference resources, and the time-domain CSI indicated via the time-domain CSI report is based at least in part on at least one of the one or more CSI reference resources.

Aspect 10: The method of any of aspects 1 through 9, wherein the time-domain CSI report is associated with at least a first time interval of the plurality of time intervals, the time-domain CSI is associated with an identified subband of the first time interval, a plurality of subbands of the first time interval, or both.

Aspect 11: The method of any of aspects 1 through 10, wherein the CSI reporting configuration is associated with an alignment between the CSI reference resource and a temporally first slot of a time interval of the plurality of time intervals, or an alignment between the CSI reference resource and a temporally last slot of the time interval of the plurality of time intervals.

Aspect 12: The method of any of aspects 1 through 11, wherein the CSI reference resource is associated with a single time interval of the plurality of time intervals, and the time-domain CSI is associated with the single time interval.

Aspect 13: A method for wireless communication at a network entity, comprising: transmitting, to a UE, control signaling indicating a CSI reporting configuration for time-domain CSI reporting associated with a plurality of time intervals, wherein the CSI reporting configuration indicates an association between the plurality of time intervals and a CSI reference resource, and wherein the CSI reference resource is included within one of the plurality of time intervals; transmitting one or more CSI-RSs in accordance with the CSI reporting configuration; and receiving, from the UE and based at least in part on the transmitting the one or more CSI-RSs, a time-domain CSI report indicating time-domain CSI associated with the plurality of time intervals.

Aspect 14: The method of aspect 13, further comprising: receiving, via the time-domain CSI report, one or more PMIs associated with the plurality of time intervals, wherein the one or more PMIs based at least in part on the measured time-domain CSI, the predicted time-domain CSI, or both.

Aspect 15: The method of any of aspects 13 through 14, wherein the CSI reporting configuration is associated with an alignment between the CSI reference resource and a temporally first time interval of the plurality of time intervals, and the predicted time-domain CSI is based at least in part on the one or more CSI-RSs transmitted within the temporally first time interval, within the CSI reference resource, or both, the time-domain CSI report comprises the predicted time-domain CSI.

Aspect 16: The method of any of aspects 13 through 15, wherein the CSI reporting configuration is associated with an alignment between the CSI reference resource and a temporally last time interval of the plurality of time intervals, and the measured time-domain CSI is based at least in part on the one or more CSI-RSs transmitted prior to the CSI reference resource and during the plurality of time intervals, the time-domain CSI report comprises the measured time-domain CSI.

Aspect 17: The method of any of aspects 13 through 16, wherein the CSI reporting configuration is associated with an alignment between the CSI reference resource and an indicated time interval of the plurality of time intervals, the measured time-domain CSI is associated with a first subset of the plurality of time intervals prior to the indicated time interval based at least in part on the one or more CSI-RSs transmitted prior to the CSI reference resource and during the first subset of the plurality of time intervals, and the predicted time-domain CSI is associated with a second subset of the plurality of time intervals subsequent to the indicated time interval based at least in part on the one or more CSI-RSs transmitted prior to the CSI reference resource and during the first subset of the plurality of time intervals, the time-domain CSI report comprises the measured time-domain CSI associated with the first subset of time intervals and the predicted time-domain CSI associated with the second subset of time intervals.

Aspect 18: The method of any of aspects 13 through 17, further comprising: receiving, via the time-domain CSI report, an indication of an alignment between a time interval of the plurality of time intervals and the CSI reference resource based at least in part on the CSI reporting configuration.

Aspect 19: The method of any of aspects 13 through 18, wherein the CSI reporting configuration is associated with a plurality of CSI reference resources within the plurality of time intervals, and the measured time-domain CSI is associated with one or more time intervals of the plurality of time intervals that include at least one CSI reference resource from the plurality of CSI reference resources.

Aspect 20: The method of any of aspects 13 through 19, wherein a time interval of the plurality of time intervals comprises a set of one or more CSI reference resources, and the measured time-domain CSI indicated via the time-domain CSI report is based at least in part on at least one of the one or more CSI reference resources.

Aspect 21: The method of any of aspects 13 through 20, wherein the time-domain CSI report is associated with at least a first time interval of the plurality of time intervals, the measured time-domain CSI, the predicted time-domain CSI, or both, is associated with an identified subband of the first time interval, a plurality of subbands of the first time interval, or both.

Aspect 22: The method of any of aspects 13 through 21, wherein the CSI reporting configuration is associated with an alignment between the CSI reference resource and a temporally first slot of a time interval of the plurality of time intervals, or an alignment between the CSI reference resource and a temporally last slot of the time interval of the plurality of time intervals.

Aspect 23: An apparatus for wireless communication at a UE, comprising a processor; memory coupled with the processor; and instructions stored in the memory and executable by the processor to cause the apparatus to perform a method of any of aspects 1 through 12.

Aspect 24: An apparatus for wireless communication at a UE, comprising at least one means for performing a method of any of aspects 1 through 12.

Aspect 25: A non-transitory computer-readable medium storing code for wireless communication at a UE, the code comprising instructions executable by a processor to perform a method of any of aspects 1 through 12.

Aspect 26: An apparatus for wireless communication at a network entity, comprising a processor; memory coupled with the processor; and instructions stored in the memory and executable by the processor to cause the apparatus to perform a method of any of aspects 13 through 22.

Aspect 27: An apparatus for wireless communication at a network entity, comprising at least one means for performing a method of any of aspects 13 through 22.

Aspect 28: A non-transitory computer-readable medium storing code for wireless communication at a network entity, the code comprising instructions executable by a processor to perform a method of any of aspects 13 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive, from a network entity, control signaling indicating a channel state information reporting configuration for time-domain channel state information reporting associated with a plurality of time intervals, wherein the channel state information reporting configuration indicates an association between the plurality of time intervals and a channel state information reference resource, and wherein the channel state information reference resource is included within one of the plurality of time intervals; and
transmit, to the network entity and based at least in part on the channel state information reporting configuration, a time-domain channel state information report indicating time-domain channel state information associated with the plurality of time intervals.

2. The apparatus of claim 1, wherein the instructions are further executable by the processor to cause the apparatus to:
transmit, via the time-domain channel state information report, one or more precoding matrix indicators associated with the plurality of time intervals, wherein the one or more precoding matrix indicators are based at least in part on the time-domain channel state information.

3. The apparatus of claim 1, wherein the instructions are further executable by the processor to cause the apparatus to:
perform measurement of, prediction based at least in part on, or both, one or more channel state information reference signals in accordance with the channel state information reporting configuration; and
transmit, via the time-domain channel state information report, an indication of measured time-domain channel state information, predicted time-domain channel state information, or both, associated with the plurality of time intervals, wherein the time-domain channel state information is based at least in part on the performing.

4. The apparatus of claim 1, wherein the channel state information reporting configuration is associated with an alignment between the channel state information reference resource and a temporally first time interval of the plurality of time intervals, and the instructions are further executable by the processor to cause the apparatus to:
determine the time-domain channel state information based at least in part on one or more channel state information reference signals received within the temporally first time interval, within the channel state information reference resource, or both.

5. The apparatus of claim 1, wherein the channel state information reporting configuration is associated with an alignment between the channel state information reference resource and a temporally last time interval of the plurality of time intervals, and the instructions are further executable by the processor to cause the apparatus to:
determine the time-domain channel state information based at least in part on one or more channel state information reference signals received prior to the channel state information reference resource and during the plurality of time intervals.

6. The apparatus of claim 1, wherein the channel state information reporting configuration is associated with an alignment between the channel state information reference resource and an indicated time interval of the plurality of time intervals, and the instructions are further executable by the processor to cause the apparatus to:
determine first time-domain channel state information associated with a first subset of the plurality of time intervals prior to the indicated time interval based at least in part on one or more channel state information reference signals received prior to the channel state information reference resource and during the first subset of the plurality of time intervals; and
determine second time-domain channel state information associated with a second subset of the plurality of time intervals subsequent to the indicated time interval based at least in part on one or more additional channel state information reference signals received prior to the channel state information reference resource and during the first subset of the plurality of time intervals, wherein the time-domain channel state information comprises the first time-domain channel state information associated with the first subset of the plurality of time intervals and the second time-domain channel state information associated with the second subset of the plurality of time intervals.

7. The apparatus of claim 1, wherein the instructions are further executable by the processor to cause the apparatus to:
determine an alignment between a time interval of the plurality of time intervals and the channel state information reference resource based at least in part on the channel state information reporting configuration; and
transmit, via the time-domain channel state information report, an indication of the determined alignment.

8. The apparatus of claim 1, wherein the channel state information reporting configuration is associated with a plurality of channel state information reference resources within the plurality of time intervals, and wherein the time-domain channel state information is associated with one or more time intervals of the plurality of time intervals that include at least one channel state information reference resource from the plurality of channel state information reference resources.

9. The apparatus of claim 1, wherein a time interval of the plurality of time intervals comprises a set of one or more channel state information reference resources, and wherein the time-domain channel state information indicated via the time-domain channel state information report is based at least in part on at least one of the one or more channel state information reference resources.

10. The apparatus of claim 1, wherein the time-domain channel state information report is associated with at least a first time interval of the plurality of time intervals, and wherein the time-domain channel state information is associated with an identified subband of the first time interval, a plurality of subbands of the first time interval, or both.

11. The apparatus of claim 1, wherein the channel state information reporting configuration is associated with an alignment between the channel state information reference resource and a temporally first slot of a time interval of the plurality of time intervals, or an alignment between the channel state information reference resource and a temporally last slot of the time interval of the plurality of time intervals.

12. The apparatus of claim 1, wherein the channel state information reference resource is associated with a single time interval of the plurality of time intervals, and wherein the time-domain channel state information is associated with the single time interval.

13. An apparatus for wireless communication at a network entity, comprising:
a processor;
memory coupled with the processor; and
instructions stored in the memory and executable by the processor to cause the apparatus to:
transmit, to a user equipment (UE), control signaling indicating a channel state information reporting configuration for time-domain channel state information reporting associated with a plurality of time intervals, wherein the channel state information reporting configuration indicates an association between the plurality of time intervals and a channel state information reference resource, and wherein the channel state information reference resource is included within one of the plurality of time intervals;
transmit one or more channel state information reference signals in accordance with the channel state information reporting configuration; and
receive, from the UE and based at least in part on the transmitting the one or more channel state information reference signals, a time-domain channel state information report indicating time-domain channel state information associated with the plurality of time intervals.

14. The apparatus of claim 13, wherein the instructions are further executable by the processor to cause the apparatus to:
receive, via the time-domain channel state information report, one or more precoding matrix indicators associated with the plurality of time intervals, wherein the one or more precoding matrix indicators based at least in part on the time-domain channel state information.

15. The apparatus of claim 13, wherein the channel state information reporting configuration is associated with an alignment between the channel state information reference resource and a temporally first time interval of the plurality of time intervals, and wherein the time-domain channel state information is based at least in part on the one or more channel state information reference signals transmitted within the temporally first time interval, within the channel state information reference resource, or both.

16. The apparatus of claim 13, wherein the channel state information reporting configuration is associated with an alignment between the channel state information reference resource and a temporally last time interval of the plurality of time intervals, and wherein the time-domain channel state information is based at least in part on the one or more channel state information reference signals transmitted prior to the channel state information reference resource and during the plurality of time intervals.

17. The apparatus of claim 13, wherein the channel state information reporting configuration is associated with an alignment between the channel state information reference resource and an indicated time interval of the plurality of time intervals, and wherein the time-domain channel state information includes first time-domain channel state information and second time-domain channel state information,
wherein the first time-domain channel state information is associated with a first subset of the plurality of time intervals prior to the indicated time interval based at least in part on the one or more channel state information reference signals transmitted prior to the channel state information reference resource and during the first subset of the plurality of time intervals, and
wherein the second time-domain channel state information is associated with a second subset of the plurality of time intervals subsequent to the indicated time interval based at least in part on the one or more channel state information reference signals transmitted prior to the channel state information reference resource and during the first subset of the plurality of time intervals.

18. The apparatus of claim 13, wherein the instructions are further executable by the processor to cause the apparatus to:
receive, via the time-domain channel state information report, an indication of an alignment between a time interval of the plurality of time intervals and the channel state information reference resource based at least in part on the channel state information reporting configuration.

19. The apparatus of claim 13, wherein the channel state information reporting configuration is associated with a plurality of channel state information reference resources within the plurality of time intervals, and wherein the time-domain channel state information is associated with one or more time intervals of the plurality of time intervals that include at least one channel state information reference resource from the plurality of channel state information reference resources.

20. The apparatus of claim 13, wherein a time interval of the plurality of time intervals comprises a set of one or more channel state information reference resources, and wherein the time-domain channel state information indicated via the time-domain channel state information report is based at least in part on at least one of the one or more channel state information reference resources.

21. The apparatus of claim 13, wherein the time-domain channel state information report is associated with at least a first time interval of the plurality of time intervals, and wherein the time-domain channel state information is associated with an identified subband of the first time interval, a plurality of subbands of the first time interval, or both.

22. The apparatus of claim 13, wherein the channel state information reporting configuration is associated with an alignment between the channel state information reference resource and a temporally first slot of a time interval of the plurality of time intervals, or an alignment between the channel state information reference resource and a temporally last slot of the time interval of the plurality of time intervals.

23. A method for wireless communication at a user equipment (UE), comprising:
receiving, from a network entity, control signaling indicating a channel state information reporting configuration for time-domain channel state information reporting associated with a plurality of time intervals, wherein the channel state information reporting configuration indicates an association between the plurality of time intervals and a channel state information reference resource, and wherein the channel state information reference resource is included within one of the plurality of time intervals; and
transmitting, to the network entity and based at least in part on the channel state information reporting configuration, a time-domain channel state information report indicating time-domain channel state information associated with the plurality of time intervals.

24. The method of claim 23, further comprising:
transmitting, via the time-domain channel state information report, one or more precoding matrix indicators associated with the plurality of time intervals, wherein the one or more precoding matrix indicators are based at least in part on the time-domain channel state information.

25. The method of claim 23, further comprising:
performing measurement of, prediction based at least in part on, or both, one or more channel state information reference signals in accordance with the channel state information reporting configuration; and
transmitting, via the time-domain channel state information report, an indication of measured time-domain channel state information, predicted time-domain channel state information, or both, associated with the plurality of time intervals, wherein the time-domain channel state information is based at least in part on the performing.

26. The method of claim 23, wherein the channel state information reporting configuration is associated with an alignment between the channel state information reference resource and a temporally first time interval of the plurality of time intervals, the method further comprising:
determining the time-domain channel state information based at least in part on one or more channel state information reference signals received within the temporally first time interval, within the channel state information reference resource, or both.

27. The method of claim 23, wherein the channel state information reporting configuration is associated with an alignment between the channel state information reference resource and a temporally last time interval of the plurality of time intervals, the method further comprising:
determining the time-domain channel state information based at least in part on one or more channel state information reference signals received prior to the channel state information reference resource and during the plurality of time intervals.

28. The method of claim 23, wherein the channel state information reporting configuration is associated with an alignment between the channel state information reference resource and an indicated time interval of the plurality of time intervals, the method further comprising:
determining first time-domain channel state information associated with a first subset of the plurality of time intervals prior to the indicated time interval based at least in part on one or more channel state information reference signals received prior to the channel state information reference resource and during the first subset of the plurality of time intervals; and
determining second time-domain channel state information associated with a second subset of the plurality of time intervals subsequent to the indicated time interval based at least in part on one or more additional channel state information reference signals received prior to the channel state information reference resource and during the first subset of the plurality of time intervals, wherein the time-domain channel state information comprises the first time-domain channel state information associated with the first subset of the plurality of time intervals and the second time-domain channel state information associated with the second subset of the plurality of time intervals.

29. A method for wireless communication at a network entity, comprising:
transmitting, to a user equipment (UE), control signaling indicating a channel state information reporting configuration for time-domain channel state information reporting associated with a plurality of time intervals, wherein the channel state information reporting configuration indicates an association between the plurality of time intervals and a channel state information reference resource, and wherein the channel state information reference resource is included within one of the plurality of time intervals;
transmitting one or more channel state information reference signals in accordance with the channel state information reporting configuration; and
receiving, from the UE and based at least in part on the transmitting the one or more channel state information reference signals, a time-domain channel state information report indicating time-domain channel state information associated with the plurality of time intervals.

30. The method of claim 29, further comprising:
receiving, via the time-domain channel state information report, one or more precoding matrix indicators associated with the plurality of time intervals, wherein the one or more precoding matrix indicators based at least in part on the time-domain channel state information.
